(19) United States
(12) Patent Application Publication
(10) Pub. No.: US 2017/0019858 A1
(43) Pub. Date: Jan. 19, 2017

(54) TECHNIQUES FOR DYNAMICALLY ENABLING OR DISABLING A USER EQUIPMENT POWER SAVING FEATURE BASED ON APPLICATION PERFORMANCE

(71) Applicant: QUALCOMM Incorporated, San Diego, CA (US)

(72) Inventors: Can ZHAO, San Diego, CA (US); Arnaud MEYLAN, San Diego, CA (US); Susheel Kumar Yadav YADAGIRI, San Diego, CA (US); Sivaramakrishna VEEREPALLI, San Diego, CA (US); Thomas REBMAN, Boulder, CO (US)

(21) Appl. No.: 15/186,209

(22) Filed: Jun. 17, 2016

Related U.S. Application Data
(60) Provisional application No. 62/192,884, filed on Jul. 15, 2015.

(51) Int. Cl. H04W 52/02

(52) U.S. Cl. CPC H04W 52/0258

(57) ABSTRACT

Aspects of the present disclosure generally relate to wireless communications. In some aspects, a device may determine, during a first time period when a power saving feature is disabled, a first performance parameter associated with an application executing on a user equipment (UE). The device may determine, during a second time period when the power saving feature is enabled, a second performance parameter associated with the application executing on the UE. The device may determine whether to enable or disable the power saving feature for the application based at least in part on the first performance parameter and the second performance parameter.

### CROSS-REFERENCE TO RELATED APPLIACATIONS

The present application for patent claims priority to U.S. Provisional Application No. 62/192,884 entitled “TECHNIQUES FOR DYNAMICALLY ENABLING OR DISABLING A USER EQUIPMENT POWER SAVING FEATURE BASED ON APPLICATION PERFOR-MANCE” filed Jul. 15, 2015, which is assigned to the assignee hereof and hereby expressly incorporated by reference in its entirety herein.

### FIELD OF DISCLOSURE

Aspects of the present disclosure generally relate to wireless communications, and more particularly to techniques for dynamically enabling or disabling a user equipment power saving feature based on application performance.

### DESCRIPTION OF RELATED ART

Wireless communication systems are widely deployed to provide various telecommunication services, such as telephony, video, data, messaging, and broadcasts. Typical wireless communication systems may employ multiple-access technologies capable of supporting communication with multiple users by sharing available system resources (e.g., bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, using new spectrum, and integrating with other open standards using OFDMA on the downlink (DL), SC-FDMA on the uplink (UL), and multiple-input multiple-output (MIMO) antenna technology.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method for wireless communication may include determining, by a user equipment (UE) and during a first time period when a power saving feature is disabled, a first performance parameter associated with an application executing on the UE. The described aspects further include determining, by the UE and during a second time period when the power saving feature is enabled, a second performance parameter associated with the application executing on the UE. The described aspects further include determining, by the UE, whether to enable or disable the power saving feature for the application based at least in part on the first performance parameter and the second performance parameter.

Further, the described aspects include wherein determining whether to enable or disable the power saving feature comprises comparing the first performance parameter and the second performance parameter, determining whether to enable or disable the power saving feature based at least in part on comparing the first performance parameter and the second performance parameter, and enabling or disabling, by the UE, the power saving feature for the application based at least in part on determining whether to enable or disable the power saving feature for the application. The described aspects further include wherein the first performance parameter or the second performance parameter comprises at least one of a number of times that the UE exits an idle mode, a number of times that the UE enters a radio resource control (RRC) connected mode, a number of messages received, or a number of RRC connections triggered by the application.

The described aspects further include wherein determining the first performance parameter or determining the second performance parameter comprises determining that a duration of the first time period or the second time period satisfies a threshold, and determining the first performance parameter or determining the second performance parameter based at least in part on determining that the duration of the first time period or the second time period satisfies the threshold. The described aspects further include wherein the first performance parameter or the second performance parameter is modified using a weight value. The described aspects further include wherein the first time period and the second time period are time periods during which a user is not actively using the UE.

The described aspects further include wherein determining the first performance parameter and determining the second performance parameter comprises detecting that the application has been installed or updated on the UE, and determining the first performance parameter and determining the second performance parameter based at least in part on detecting that the application has been installed or updated on the UE. The described aspects further include wherein determining the first performance parameter and determining the second performance parameter comprises determining that a threshold period of time has elapsed since a prior determination of whether to enable or disable the power saving feature, and determining the first performance parameter and determining the second performance parameter based at least in part on determining that the threshold period of time has elapsed since the prior determination.

The described aspects further include wherein the application is a first application, wherein the power saving feature is enabled for the first application during a third time period, and wherein the power saving feature is disabled for a second application during the third time period. The described aspects further include disabling the power saving feature for the application at a first time, determining to re-evaluate whether to enable or disable the power saving feature for the application after disabling the power saving feature for the application, determining, during a third time period when the power saving feature is disabled, a third performance parameter associated with the application, determining, during a fourth time period when the power saving feature is enabled, a fourth performance parameter associated with the application, and determining, based at least in part on determining to re-evaluate, whether to enable or disable the power saving feature for the application at a second time based at least in part on the third performance parameter and the fourth performance parameter.

The described aspects further include enabling the power saving feature for the application at a first time, determining to re-evaluate whether to enable or disable the power saving feature for the application after enabling the power saving feature for the application, determining, during a third time period when the power saving feature is enabled, a third performance parameter associated with the application, comparing the third performance parameter and the second performance parameter, and determining, based at least in part on determining to re-evaluate, whether to enable or disable the power saving feature for the application at a second time based at least in part on comparing the third performance parameter and the second performance parameter.

The described aspects further include wherein the first time period and the second time period include at least one learning time period during which a user is not actively using the UE, wherein the at least one learning time period begins after expiration of a margin time period, wherein the margin time period begins after detecting that the user is not actively using the UE, wherein a duration of the at least one learning time period satisfies a threshold, and further comprising periodically determining whether the application is executing during the at least one learning time period. The described aspects further include wherein the application is executing during the first time period and the second time period.

The described aspects further include wherein determining the first performance parameter or determining the second performance parameter comprises determining that a user is not actively using the UE, determining that the application has been executing on the UE for a threshold amount of time, monitoring the UE for information relating to the first performance parameter or the second performance parameter based at least in part on determining that the user is not actively using the UE and determining that the application has been executing on the UE for the threshold amount of time, determining the first performance parameter or determining the second performance parameter based at least in part on monitoring the UE for the information relating to the first performance parameter or the second performance parameter, and determining that the user is actively using the UE or that the application has stopped executing on the UE, and stopping the monitoring of the UE for the information relating to the first performance parameter or the second performance parameter based at least in part on determining that the user is actively using the UE or that the application has stopped executing on the UE. The described aspects further include wherein the first time period or the second time period includes a plurality of time periods during which a user is not actively using the UE and during which the application is executing on the UE. The described aspects further include wherein the power saving feature is a mode of a power saving application.

In another aspect, an apparatus for wireless communication may include a memory configured to store instructions, and one or more processors communicatively coupled with the memory, wherein the one or more processors and the memory are configured to determine, during a first time period when a power saving feature is disabled, a first performance parameter associated with an application executing on the UE. The described aspects determine, during a second time period when the power saving feature is enabled, a second performance parameter associated with the application executing on the UE. The described aspects further determine whether to enable or disable the power saving feature for the application based at least in part on the first performance parameter and the second performance parameter.

The described aspects further enable or disable the power saving feature for the application based at least in part on determining whether to enable or disable the power saving feature for the application. The described aspects further compare the first performance parameter and the second performance parameter, and determine whether to enable or disable the power saving feature based at least in part on comparing the first performance parameter and the second performance parameter. The described aspects further include wherein the first performance parameter or the second performance parameter comprises at least one of a number of times that the UE exits an idle mode, a number of times that the UE enters a RRC connected mode, a number of messages received, or a number of RRC connections triggered by the application.

The described aspects further include wherein the one or more processors, when determining the first performance parameter or determining the second performance parameter, are to determine that a duration of the first time period or the second time period satisfies a threshold, and determine the first performance parameter or determine the second performance parameter based at least in part on determining that the duration of the first time period or the second time period satisfies the threshold. The described aspects further include wherein the first performance parameter or the second performance parameter is modified using a weight value. The described aspects further include wherein the first time period and the second time period are time periods during which a user is not actively using the UE.

The described aspects further include wherein the one or more processors, when determining the first performance parameter and determining the second performance parameter, are to detect that the application has been installed or updated on the UE, and determine the first performance parameter and determine the second performance parameter based at least in part on detecting that the application has been installed or updated on the UE. The described aspects further include wherein the one or more processors, when determining the first performance parameter and determining the second performance parameter, are to determine that a threshold period of time has elapsed since a prior determination of whether to enable or disable the power saving feature, and determine the first performance parameter and determine the second performance parameter based at least in part on determining that the threshold period of time has elapsed since the prior determination.

The described aspects further include wherein the application is a first application, wherein the power saving feature is enabled for the first application during a third time period, and wherein the power saving feature is disabled for a second application during the third time period. The described aspects further disable the power saving feature for the application at a first time, determine to re-evaluate whether to enable or disable the power saving feature for the application after disabling the power saving feature for the application, determine, during a third time period when the power saving feature is disabled, a third performance parameter associated with the application, determine, during a fourth time period when the power saving feature is enabled, a fourth performance parameter associated with the application, and determine, based at least in part on determining to re-evaluate, whether to enable or disable the power saving feature for the application at a second time based at least in part on the third performance parameter and the fourth performance parameter.

The described aspects further enable the power saving feature for the application at a first time, determine to re-evaluate whether to enable or disable the power saving feature for the application after enabling the power saving feature for the application, determine, during a third time period when the power saving feature is enabled, a third performance parameter associated with the application, compare the third performance parameter and the second performance parameter, and determine, based at least in part on determining to re-evaluate, whether to enable or disable the power saving feature for the application at a second time based at least in part on comparing the third performance parameter and the second performance parameter. The described aspects further include wherein the first time period and the second time period include at least one learning time period during which a user is not actively using the UE.

The described aspects further include wherein the at least one learning time period begins after expiration of a margin time period, and wherein the margin time period begins after detecting that the user is not actively using the UE. The described aspects further include wherein a duration of the at least one learning time period satisfies a threshold. The described aspects further periodically determine whether the application is executing during the at least one learning time period. The described aspects further include wherein the application is executing during the first time period and the second time period. The described aspects further include wherein the first time period or the second time period includes a plurality of time periods during which a user is not actively using the UE and during which the application is executing on the UE.

The described aspects further include wherein the one or more processors, when determining the first performance parameter or determining the second performance parameter, are to determine that a user is not actively using the UE, determine that the application has been executing on the UE for a threshold amount of time, monitor the UE for information relating to the first performance parameter or the second performance parameter based at least in part on determining that the user is not actively using the UE and determining that the application has been executing on the UE for the threshold amount of time, and determine the first performance parameter or determine the second performance parameter based at least in part on monitoring the UE for the information relating to the first performance parameter or the second performance parameter.

The described aspects further determine that the user is actively using the UE or that the application has stopped executing on the UE, and stop the monitoring of the UE for the information relating to the first performance parameter or the second performance parameter based at least in part on determining that the user is actively using the UE or that the application has stopped executing on the UE. The described aspects further include wherein the power saving feature is a mode of a power saving application.

In another aspect, a computer-readable medium may store computer executable code for wireless communication. The described aspects include code for determining, during a first time period when a power saving feature is disabled, a first performance parameter associated with an application executing on the UE. The described aspects include code for determining, during a second time period when the power saving feature is enabled, a second performance parameter associated with the application executing on the UE. The described aspects include code for determining whether to enable or disable the power saving feature for the application based at least in part on the first performance parameter and the second performance parameter.

Further, the described aspects include wherein the code for determining whether to enable or disable the power saving feature comprises code for comparing the first performance parameter and the second performance parameter, code for determining whether to enable or disable the power saving feature based at least in part on comparing the first performance parameter and the second performance parameter, and code for enabling or disabling, by the UE, the power saving feature for the application based at least in part on determining whether to enable or disable the power saving feature for the application. The described aspects further include wherein the first performance parameter or the second performance parameter comprises at least one of a number of times that the UE exits an idle mode, a number of times that the UE enters a RRC connected mode, a number of messages received, or a number of RRC connections triggered by the application.

The described aspects further include wherein the code for determining the first performance parameter or determining the second performance parameter comprises code for determining that a duration of the first time period or the second time period satisfies a threshold, and code for determining the first performance parameter or determining the second performance parameter based at least in part on determining that the duration of the first time period or the second time period satisfies the threshold. The described aspects further include wherein the first performance parameter or the second performance parameter is modified using a weight value. The described aspects further include wherein the first time period and the second time period are time periods during which a user is not actively using the UE.

The described aspects further include wherein the code for determining the first performance parameter and the code for determining the second performance parameter comprises code for detecting that the application has been installed or updated on the UE, and code for determining the first performance parameter and determining the second performance parameter based at least in part on detecting that the application has been installed or updated on the UE. The described aspects further include wherein the code for determining the first performance parameter and the code for determining the second performance parameter comprises code for determining that a threshold period of time has elapsed since a prior determination of whether to enable or disable the power saving feature, and code for determining the first performance parameter and code for determining the second performance parameter based at least in part on determining that the threshold period of time has elapsed since the prior determination.

The described aspects further include wherein the application is a first application, wherein the power saving feature is enabled for the first application during a third time period, and wherein the power saving feature is disabled for a second application during the third time period. The described aspects further include code for disabling the power saving feature for the application at a first time, code for determining to re-evaluate whether to enable or disable the power saving feature for the application after disabling the power saving feature for the application, code for determining, during a third time period when the power saving feature is disabled, a third performance parameter associated with the application, code for determining, during a fourth time period when the power saving feature is enabled, a fourth performance parameter associated with the application, and code for determining, based at least in part on determining to re-evaluate, whether to enable or disable the power saving feature for the application at a second time based at least in part on the third performance parameter and the fourth performance parameter.

The described aspects further include code for enabling the power saving feature for the application at a first time, code for determining to re-evaluate whether to enable or disable the power saving feature for the application after enabling the power saving feature for the application, code for determining, during a third time period when the power saving feature is enabled, a third performance parameter associated with the application, code for comparing the third performance parameter and the second performance parameter, and code for determining, based at least in part on determining to re-evaluate, whether to enable or disable the power saving feature for the application at a second time based at least in part on comparing the third performance parameter and the second performance parameter. The described aspects further include wherein the first time period and the second time period include at least one learning time period during which a user is not actively using the UE, wherein the at least one learning time period begins after expiration of a margin time period, wherein the margin time period begins after detecting that the user is not actively using the UE, wherein a duration of the at least one learning time period satisfies a threshold, and further comprising code for periodically determining whether the application is executing during the at least one learning time period.

The described aspects further include wherein the application is executing during the first time period and the second time period. The described aspects further include wherein the code for determining the first performance parameter or the code for determining the second performance parameter comprises code for determining that a user is not actively using the UE, code for determining that the application has been executing on the UE for a threshold amount of time, code for monitoring the UE for information relating to the first performance parameter or the second performance parameter based at least in part on determining that the user is not actively using the UE and determining that the application has been executing on the UE for the threshold amount of time, code for determining the first performance parameter or determining the second performance parameter based at least in part on monitoring the UE for the information relating to the first performance parameter or the second performance parameter, and code for determining that the user is actively using the UE or that the application has stopped executing on the UE, and code for stopping the monitoring of the UE for the information relating to the first performance parameter or the second performance parameter based at least in part on determining that the user is actively using the UE or that the application has stopped executing on the UE. The described aspects further include wherein the first time period or the second time period includes a plurality of time periods during which a user is not actively using the UE and during which the application is executing on the UE. The described aspects further include wherein the power saving feature is a mode of a power saving application.

In another aspect, an apparatus for wireless communication may include means for determining, during a first time period when a power saving feature is disabled, a first performance parameter associated with an application executing on a UE. The described aspects include means for determining, during a second time period when the power saving feature is enabled, a second performance parameter associated with the application executing on the UE. The described aspects further include means for determining whether to enable or disable the power saving feature for the application based at least in part on the first performance parameter and the second performance parameter. The described aspects further include means for enabling or disabling the power saving feature for the application based at least in part on determining whether to enable or disable the power saving feature for the application.

Further, the described aspects include wherein the means for determining whether to enable or disable the power saving feature comprises means for comparing the first performance parameter and the second performance parameter, means for determining whether to enable or disable the power saving feature based at least in part on comparing the first performance parameter and the second performance parameter, and means for enabling or disabling, by the UE, the power saving feature for the application based at least in part on determining whether to enable or disable the power saving feature for the application. The described aspects further include wherein the first performance parameter or the second performance parameter comprises at least one of a number of times that the UE exits an idle mode, a number of times that the UE enters a RRC connected mode, a number of messages received, or a number of RRC connections triggered by the application.

The described aspects further include wherein the means for determining the first performance parameter or determining the second performance parameter comprises means for determining that a duration of the first time period or the second time period satisfies a threshold, and means for determining the first performance parameter or determining the second performance parameter based at least in part on determining that the duration of the first time period or the second time period satisfies the threshold. The described aspects further include wherein the first performance parameter or the second performance parameter is modified using a weight value. The described aspects further include wherein the first time period and the second time period are time periods during which a user is not actively using the UE.

The described aspects further include wherein the means for determining the first performance parameter and the means for determining the second performance parameter comprises means for detecting that the application has been installed or updated on the UE, and means for determining the first performance parameter and determining the second performance parameter based at least in part on detecting that the application has been installed or updated on the UE. The described aspects further include wherein the means for determining the first performance parameter and the means for determining the second performance parameter comprises means for determining that a threshold period of time has elapsed since a prior determination of whether to enable or disable the power saving feature, and means for determining the first performance parameter and means for determining the second performance parameter based at least in part on determining that the threshold period of time has elapsed since the prior determination.

The described aspects further include wherein the application is a first application, wherein the power saving feature is enabled for the first application during a third time period, and wherein the power saving feature is disabled for a second application during the third time period. The described aspects further include means for disabling the power saving feature for the application at a first time, means for determining to re-evaluate whether to enable or disable the power saving feature for the application after disabling the power saving feature for the application, means for determining, during a third time period when the power saving feature is disabled, a third performance parameter associated with the application, means for determining, during a fourth time period when the power saving feature is enabled, a fourth performance parameter associated with the application, and means for determining, based at least in part on determining to re-evaluate, whether to enable or disable the power saving feature for the application at a second time based at least in part on the third performance parameter and the fourth performance parameter.

The described aspects further include means for enabling the power saving feature for the application at a first time, means for determining to re-evaluate whether to enable or disable the power saving feature for the application after enabling the power saving feature for the application, means for determining, during a third time period when the power saving feature is enabled, a third performance parameter associated with the application, means for comparing the third performance parameter and the second performance parameter, and means for determining, based at least in part on determining to re-evaluate, whether to enable or disable the power saving feature for the application at a second time based at least in part on comparing the third performance parameter and the second performance parameter. The described aspects further include wherein the first time period and the second time period include at least one learning time period during which a user is not actively using the UE, wherein the at least one learning time period begins after expiration of a margin time period, wherein the margin time period begins after detecting that the user is not actively using the UE, wherein a duration of the at least one learning time period satisfies a threshold, and further comprising means for periodically determining whether the application is executing during the at least one learning time period.

The described aspects further include wherein the application is executing during the first time period and the second time period. The described aspects further include wherein the means for determining the first performance parameter or the means for determining the second performance parameter comprises means for determining that a user is not actively using the UE, means for determining that the application has been executing on the UE for a threshold amount of time, means for monitoring the UE for information relating to the first performance parameter or the second performance parameter based at least in part on determining that the user is not actively using the UE and determining that the application has been executing on the UE for the threshold amount of time, means for determining the first performance parameter or determining the second performance parameter based at least in part on monitoring the UE for the information relating to the first performance parameter or the second performance parameter, and means for determining that the user is actively using the UE or that the application has stopped executing on the UE, and means for stopping the monitoring of the UE for the information relating to the first performance parameter or the second performance parameter based at least in part on determining that the user is actively using the UE or that the application has stopped executing on the UE. The described aspects further include wherein the first time period or the second time period includes a plurality of time periods during which a user is not actively using the UE and during which the application is executing on the UE. The described aspects further include wherein the power saving feature is a mode of a power saving application.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is an illustration of an example wireless communication system, in accordance with various aspects of the present disclosure;

FIG. 2 is a diagram illustrating an example access network in an LTE network architecture, in accordance with various aspects of the present disclosure;

FIG. 3 is a diagram illustrating an example of a downlink (DL) frame structure in LTE, in accordance with various aspects of the present disclosure;

FIG. 4 is a diagram illustrating an example of an uplink (UL) frame structure in LTE, in accordance with various aspects of the present disclosure;

FIG. 5 is a diagram illustrating an example of a radio protocol architecture for a user plane and a control plane in LTE, in accordance with various aspects of the present disclosure;

FIG. 6 is a diagram illustrating example components of a communication system including a base station and a UE, in accordance with various aspects of the present disclosure;

FIG. 7 is a diagram of a wireless communication system including a UE having a power saving component configured to dynamically enable or disable a power saving feature in accordance with various aspects of the present disclosure;

FIG. 8A is diagram illustrating an example of determining whether to enable or disable a power saving feature for an application, in accordance with various aspects of the present disclosure;

FIG. 8B is a diagram illustrating an example of determining whether to enable or disable a power saving feature for an application, in accordance with various aspects of the present disclosure;

FIG. 9A is a diagram illustrating an example of triggering an evaluation and a re-evaluation of whether to enable or disable a power saving feature for an application, in accordance with various aspects of the present disclosure;

FIG. 9B is a diagram illustrating an example of triggering an evaluation and a re-evaluation of whether to enable or disable a power saving feature for an application, in accordance with various aspects of the present disclosure;

FIG. 9C is a diagram illustrating an example of triggering an evaluation and a re-evaluation of whether to enable or disable a power saving feature for an application, in accordance with various aspects of the present disclosure;

FIG. 9D is a diagram illustrating an example of one or more lists of applications used to determine whether to enable or disable a power saving feature for an application, in accordance with various aspects of the present disclosure;

FIG. 10 is a diagram illustrating an example of determining a learning time period during which to monitor for information relating to performance parameters associated with determining whether to enable or disable a power saving feature for an application, in accordance with various aspects of the present disclosure;

FIG. 11 is a diagram illustrating an example of determining a learning time period for an application based at least in part on determining whether the application is executing, in accordance with various aspects of the present disclosure;

FIG. 12 is a flow diagram of an example process for determining whether to enable or disable a power saving feature for an application, in accordance with various aspects of the present disclosure;

FIG. 13 is a flow diagram of an example process for re-evaluating whether to enable or disable a power saving feature for an application after the power saving feature has been disabled for the application, in accordance with various aspects of the present disclosure;

FIG. 14 is a flow diagram of an example process for re-evaluating whether to enable or disable a power saving feature for an application after the power saving feature has been enabled for the application, in accordance with various aspects of the present disclosure;

FIG. 15 is a flow diagram illustrating the data flow between different means/components in an exemplary apparatus including a power saving component in accordance with various aspects of the present disclosure; and

FIG. 16 is a diagram illustrating an example of a hardware implementation for an apparatus employing a processing system including a power saving component in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details.

A user equipment (UE) may be configured with one or more power saving features to reduce power consumption or signaling of the UE. For example, a power saving feature, such as a Network Socket Request Manager (NSRM), may group multiple communications associated with one or more applications executing on the UE. The power saving feature may power up the UE (e.g., may exit an idle mode, such as a discontinuous transmission (DTX) mode) to send the multiple communications together, rather than powering up the UE multiple times as each communication is triggered. This is one example of a power saving feature for a UE, and other power saving features may be used by the UE.

Different applications executing on the UE may behave differently in association with a power saving feature. In some cases, enabling the power saving feature for an application may increase power consumption as compared to disabling the power saving feature for the application. As an example, when a power saving feature groups communications, there may be a delay between when the application triggers a communication and when the communication is transmitted. In this case, the application may detect that a communication has not yet been transmitted, and may trigger additional communications, thereby reducing application performance and increasing power consumption due to power required to transmit the additional communications.

Because different applications behave differently, enabling the power saving feature for an application may increase or decrease power consumption as compared to disabling the power saving feature for the application. Techniques described herein may dynamically determine whether to enable or disable a power saving feature for an application based at least in part on measuring performance of the application and/or the UE with the power saving feature enabled and disabled. In this way, the UE may configure whether to enable or disable a power saving feature for an application, thereby increasing application and UE performance and reducing application and UE power consumption.

The techniques described herein may be used for one or more of various wireless communication networks, such as code division multiple access (CDMA) networks, time division multiple access (TDMA) networks, frequency division multiple access (FDMA) networks, orthogonal FDMA (OFDMA) networks, single carrier FDMA (SC-FDMA) networks, or other types of networks. A CDMA network may implement a radio access technology (RAT), such as universal terrestrial radio access (UTRA), CDMA2000, or the like. UTRA may include wideband CDMA (WCDMA) and/or other variants of CDMA. CDMA2000 may include Interim Standard (IS)-2000, IS-95 and IS-856 standards. IS-2000 may also be referred to as 1× radio transmission technology (1×RTT), CDMA2000 1×, or the like. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), Institute of Electrical and Electronics Engineers (IEEE) 802.11 (Wi-Fi), IEEE 802.16 (WiMAX), IEEE 802.20, Flash-OFDM, or the like. UTRA and E-UTRA may be part of the universal mobile telecommunication system (UMTS). 3GPP long-term evolution (LTE) and LTE-Advanced (LTE-A) are example releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and RATs mentioned above as well as other wireless networks and RATs.

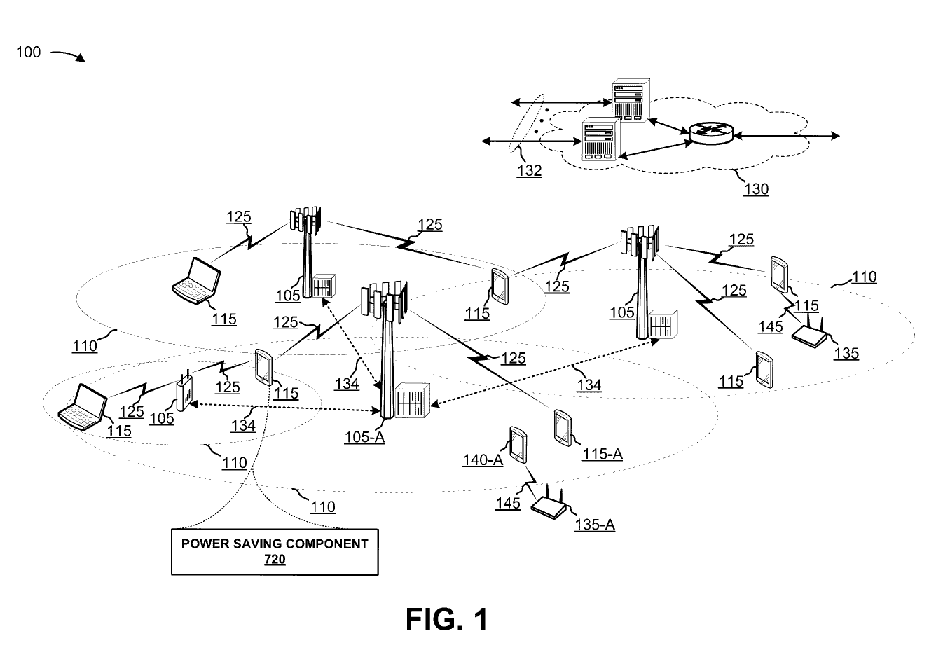

FIG. 1 is an illustration of an example wireless communication system 100, in accordance with various aspects of the disclosure. The wireless communication system 100 may include a WWAN network, such as a cellular network, and a WLAN network, such as a Wi-Fi network. The cellular network may include one or more base stations 105, 105-A, one or more UEs 115, 115-A, and a core network 130. The Wi-Fi network may include one or more WLAN access points 135, 135-A (e.g., Wi-Fi access points) and one or more WLAN stations 140, 140-A (e.g., Wi-Fi stations).

With reference to the cellular network of the wireless communication system 100, the core network 130 may provide user authentication, access authorization, tracking, Internet Protocol (IP) connectivity, and other access, routing, or mobility functions. The base stations 105, 105-A may interface with the core network 130 through backhaul links 132 (e.g., S1, etc.) and may perform radio configuration and scheduling for communication with the UEs 115, 115-A, or may operate under the control of a base station controller (not shown). In various examples, the base stations 105, 105-A may communicate, either directly or indirectly (e.g., through core network 130), with each other over backhaul links 134 (e.g., X2, etc.), which may be wired or wireless communication links.

The base stations 105, 105-A may wirelessly communicate with the UEs 115, 115-A via one or more base station antennas. Each of the base station 105, 105-A sites may provide communication coverage for a respective geographic coverage area 110. In some examples, a base station 105, 105-A may be referred to as a base transceiver station, a radio base station, an access point, a radio transceiver, a NodeB, an eNodeB (eNB), a Home NodeB, a Home eNodeB, or some other suitable terminology. The geographic coverage area 110 for a base station 105, 105-A may be divided into sectors making up a portion of the coverage area (not shown). The cellular network may include base stations 105, 105-A of different types (e.g., macro and/or small cell base stations). There may be overlapping geographic coverage areas 110 for different technologies.

In some examples, the cellular network may include an LTE/LTE-A network. In LTE/LTE-A networks, the term evolved Node B (eNB) may be used to describe the base stations 105, 105-A, while the term UE may be used to describe the UEs 115, 115-A. The cellular network may be a Heterogeneous LTE/LTE-A network in which different types of eNBs provide coverage for various geographical regions. For example, each eNB or base station 105, 105-A may provide communication coverage for a macro cell, a small cell, and/or another type of cell. The term “cell” is a 3GPP term that can be used to describe a base station, a carrier or component carrier associated with a base station, or a coverage area (e.g., sector, etc.) of a carrier or base station, depending on context.

A macro cell may cover a relatively large geographic area (e.g., several kilometers in radius) and may allow unrestricted access by UEs with service subscriptions with the network provider. A small cell may be a lower-powered base station, as compared with a macro cell that may operate in the same or different (e.g., licensed, unlicensed, etc.) radio frequency spectrum bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, or the like) cells (e.g., component carriers).

The cellular network may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The cellular network may in some examples include a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use Hybrid ARQ (HARQ) to provide retransmission at the MAC layer to improve link efficiency. In the control plane, the Radio Resource Control (RRC) protocol layer may provide establishment, configuration, and maintenance of an RRC connection between a UE 115, 115-A and the base stations 105, 105-A or core network 130 supporting radio bearers for the user plane data. At the Physical (PHY) layer, the transport channels may be mapped to Physical channels.

The UEs 115, 115-A may be dispersed throughout the wireless communication system 100, and each UE 115, 115-A may be stationary or mobile. A UE 115, 115-A may also include or be referred to by those skilled in the art as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terminology. A UE 115, 115-A may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations 105, 105-A and network equipment, including macro eNBs, small cell eNBs, relay base stations, or the like.

The communication links 125 shown in wireless communication system 100 may carry downlink (DL) transmissions from a base station 105, 105-A to a UE 115, 115-A, and/or uplink (UL) transmissions from a UE 115, 115-A to a base station 105, 105-A. The downlink transmissions may also be called forward link transmissions, while the uplink transmissions may also be called reverse link transmissions.

In some examples, each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using a frequency division duplexing (FDD) operation (e.g., using paired spectrum resources) or a time division duplexing (TDD) operation (e.g., using unpaired spectrum resources). Frame structures for FDD operation (e.g., frame structure type 1) and TDD operation (e.g., frame structure type 2) may be defined.

In some aspects of the wireless communication system 100, base stations 105, 105-A and/or UEs 115, 115-A may include multiple antennas for employing antenna diversity schemes to improve communication quality and reliability between base stations 105, 105-A and UEs 115, 115-A. Additionally or alternatively, base stations 105, 105-A and/or UEs 115, 115-A may employ multiple-input, multiple-output (MIMO) techniques that may take advantage of multi-path environments to transmit multiple spatial layers carrying the same or different coded data.

The wireless communication system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115, 115-A may be configured with multiple downlink CCs and one or more uplink CCs for carrier aggregation. Carrier aggregation may be used with both FDD and TDD component carriers.

With reference to the Wi-Fi network of the wireless communication system 100, the WLAN access points 135, 135-A may wirelessly communicate with the WLAN stations 140, 140-A via one or more WLAN access point antennas, over one or more communication links 145. In some examples, the WLAN access points 135, 135-A may communicate with the WLAN stations 140, 140-A using one or more Wi-Fi communication standards, such as an Institute of Electrical and Electronics (IEEE) Standard 802.11 (e.g., IEEE Standard 802.11a, IEEE Standard 802.11n, or IEEE Standard 802.11ac).

In some examples, a WLAN station 140, 140-A may be a cellular phone, a personal digital assistant (PDA), a wireless communication device, a handheld device, a tablet computer, a laptop computer, or the like. In some examples, an apparatus may include aspects of both a UE 115, 115-A and a WLAN station 140, 140-A, and such an apparatus may communicate with one or more base stations 105, 105-A using a first radio access technology (RAT) (e.g., a cellular RAT or multiple cellular RATs), and communicate with one or more WLAN access points 135, 135-A using a second RAT (e.g., a Wi-Fi RAT or multiple Wi-Fi RATs).

In some examples, the base stations 105, 105-A and UEs 115, 115-A may communicate over a licensed radio frequency spectrum band and/or an unlicensed radio frequency spectrum band, whereas the WLAN access points 135, 135-A and WLAN stations 140, 140-A may communicate over the unlicensed radio frequency spectrum band. The unlicensed radio frequency spectrum band may therefore be shared by the base stations 105, 105-A, the UEs 115, 115-A, the WLAN access points 135, 135-A, and/or the WLAN stations 140, 140-A.

The number and arrangement of components shown in FIG. 1 are provided as an example. In practice, wireless communication system 100 may include additional devices, fewer devices, different devices, or differently arranged devices than those shown in FIG. 1. Additionally, or alternatively, a set of devices (e.g., one or more devices) of wireless communication system 100 may perform one or more functions described as being performed by another set of devices of wireless communication system 100.

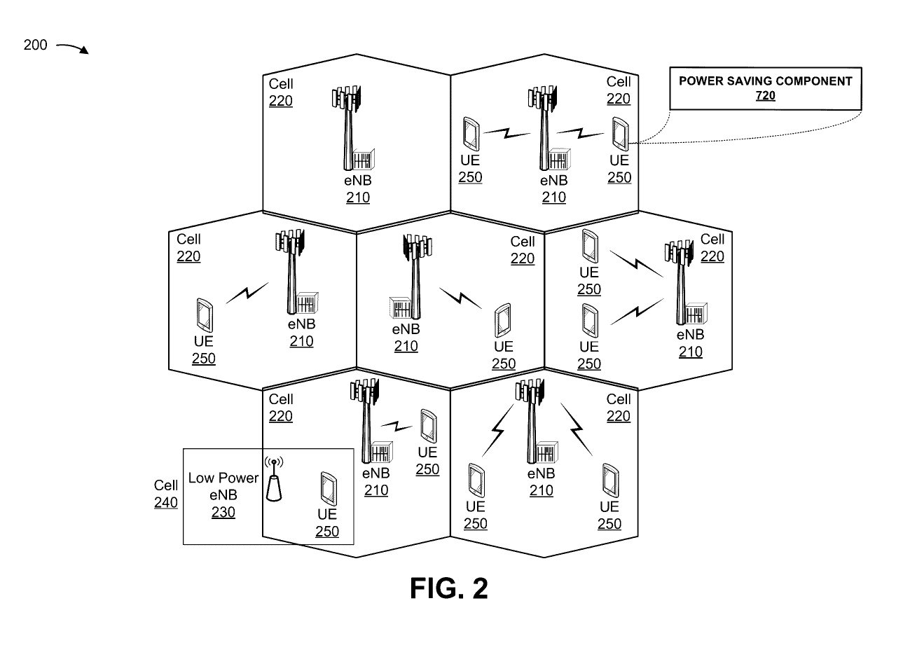

FIG. 2 is a diagram illustrating an example access network 200 in an LTE network architecture, in accordance with various aspects of the present disclosure. As shown, access network 200 may include a set of eNBs 210 that serve a corresponding set of cellular regions (cells) 220, a set of low power eNBs 230 that serve a corresponding set of cells 240, and a set of UEs 250.

Each eNB 210 may be assigned to a respective cell 220 and may be configured to provide an access point to a RAN. For example, eNB 210 may provide an access point for UE 250 to a RAN (e.g., eNB 210 may correspond to base station 105, shown in FIG. 1). UE 250 may correspond to UE 115, shown in FIG. 1. FIG. 2 does not illustrate a centralized controller for example access network 200, but access network 200 may use a centralized controller in some aspects. The eNBs 210 may perform radio related functions including radio bearer control, admission control, mobility control, scheduling, security, and network connectivity.

As shown in FIG. 2, one or more low power eNBs 230 may serve respective cells 240, which may overlap with one or more cells 220 served by eNBs 210. The low power eNBs 230 may correspond to base station 105, shown in FIG. 1. A low power eNB 230 may be referred to as a remote radio head (RRH). The low power eNB 230 may include a femto cell eNB (e.g., home eNB (HeNB)), a pico cell eNB, a micro cell eNB, or the like.

A modulation and multiple access scheme employed by access network 200 may vary depending on the particular telecommunications standard being deployed. In LTE applications, OFDM is used on the downlink (DL) and SC-FDMA is used on the uplink (UL) to support both frequency division duplexing (FDD) and time division duplexing (TDD). The various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. As another example, these concepts may also be extended to UTRA employing WCDMA and other variants of CDMA (e.g., such as TD-SCDMA, GSM employing TDMA, E-UTRA, or the like), UMB, IEEE 802.11 (Wi-Fi), IEEE 802.16 (WiMAX), IEEE 802.20, Flash-OFDM employing OFDMA, or the like. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The number and arrangement of devices and cells shown in FIG. 2 are provided as an example. In practice, there may be additional devices and/or cells, fewer devices and/or cells, different devices and/or cells, or differently arranged devices and/or cells than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

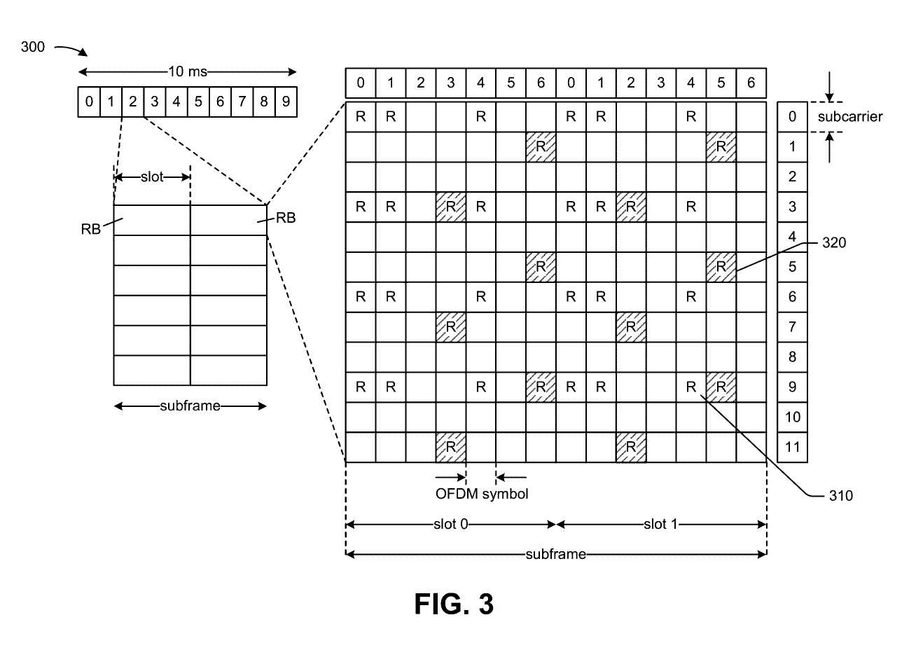

FIG. 3 is a diagram illustrating an example 300 of a downlink (DL) frame structure in LTE, in accordance with various aspects of the present disclosure. A frame (e.g., of 10 ms) may be divided into 10 equally sized sub-frames with indices of 0 through 9. Each sub-frame may include two consecutive time slots. A resource grid may be used to represent two time slots, each time slot including a resource block (RB). The resource grid is divided into multiple resource elements. In LTE, a resource block includes 12 consecutive subcarriers in the frequency domain and, for a normal cyclic prefix in each OFDM symbol, 7 consecutive OFDM symbols in the time domain, or 84 resource elements. For an extended cyclic prefix, a resource block includes 6 consecutive OFDM symbols in the time domain and has 72 resource elements. Some of the resource elements, as indicated as R 310 and R 320, include DL reference signals (DL-RS). The DL-RS include Cell-specific RS (CRS) (also sometimes called common RS) 310 and UE-specific RS (UE-RS) 320. UE-RS 320 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

As indicated above, FIG. 3 is provided as an example. Other examples are possible and may differ from what was described above in connection with FIG. 3.

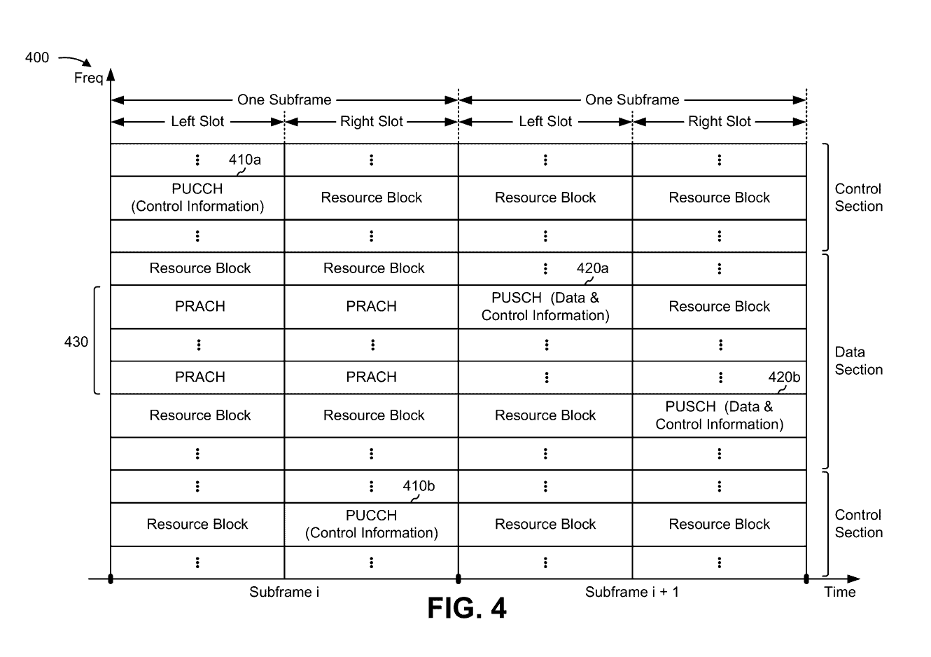

FIG. 4 is a diagram illustrating an example 400 of an uplink (UL) frame structure in LTE, in accordance with various aspects of the present disclosure. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. In some aspects, the UE may transmit only data or both data and control information in a physical UL shared channel (PUSCH) on the assigned resource blocks in the data section. A UL transmission may span both slots of a subframe and may hop across frequencies.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (e.g., of 1 ms) or in a sequence of few contiguous subframes.

As indicated above, FIG. 4 is provided as an example. Other examples are possible and may differ from what was described above in connection with FIG. 4.

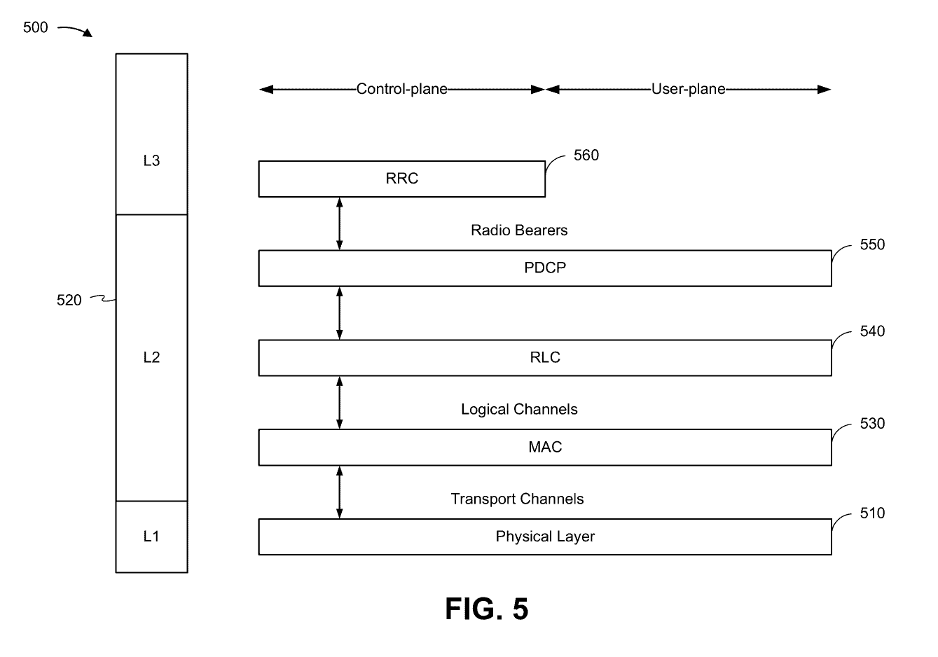

FIG. 5 is a diagram illustrating an example 500 of a radio protocol architecture for a user plane and a control plane in LTE, in accordance with various aspects of the present disclosure. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 510. Layer 2 (L2 layer) 520 is above the physical layer 510 and is responsible for the link between the UE and eNB over the physical layer 510.

In the user plane, the L2 layer 520 includes a media access control (MAC) sublayer 530, a radio link control (RLC) sublayer 540, and a packet data convergence protocol (PDCP) 550 sublayer, which are terminated at the eNB on the network side. Although not shown, the UE may have several upper layers above the L2 layer 520 including a network layer (e.g., IP layer) that is terminated at a packet data network (PDN) gateway on the network side, and an application layer that is terminated at the other end of the connection (e.g., far end UE, server, etc.).

The PDCP sublayer 550 provides multiplexing between different radio bearers and logical channels. The PDCP sublayer 550 also provides header compression for upper layer data packets to reduce radio transmission overhead, security by ciphering the data packets, and handover support for UEs between eNBs. The RLC sublayer 540 provides segmentation and reassembly of upper layer data packets, retransmission of lost data packets, and reordering of data packets to compensate for out-of-order reception due to hybrid automatic repeat request (HARQ). The MAC sublayer 530 provides multiplexing between logical and transport channels. The MAC sublayer 530 is also responsible for allocating the various radio resources (e.g., resource blocks) in one cell among the UEs. The MAC sublayer 530 is also responsible for HARQ operations.

In the control plane, the radio protocol architecture for the UE and eNB is substantially the same for the physical layer 510 and the L2 layer 520 with the exception that there is no header compression function for the control plane. In some aspects, integrity protection may be provided for the control plane data. The control plane also includes a radio resource control (RRC) sublayer 560 in Layer 3 (L3 layer). The RRC sublayer 560 is responsible for obtaining radio resources (i.e., radio bearers) and for configuring the lower layers using RRC signaling between the eNB and the UE.

As indicated above, FIG. 5 is provided as an example. Other examples are possible and may differ from what was described above in connection with FIG. 5.

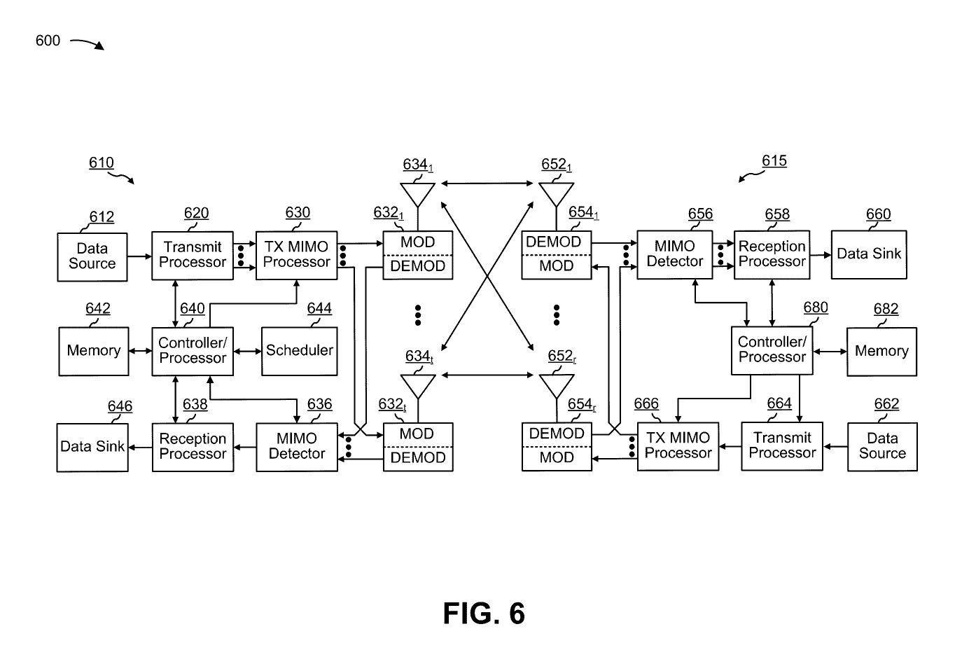

FIG. 6 is an illustration of example components of a communication system 600 including a base station 610 and a UE 615, in accordance with various aspects of the present disclosure. In some aspects, base station 610 may correspond to one or more of the base stations and/or eNBs 105, 105-A, 210, or 230 described with reference to FIG. 1 or 2. In some aspects, UE 615 may correspond to one or more of the UEs 115, 115-A, or 250 described above with reference to FIG. 1 or 2. Base station 610 may be equipped with antennas 634₁₋ₜ, and UE 615 may be equipped with antennas 652₁₋ᵣ, wherein t and r are integers greater than or equal to one.

At base station 610, a base station transmit processor 620 may receive data from a base station data source 612 and control information from a base station controller/processor 640. The control information may be carried on the Physical Broadcast Channel (PBCH), the Physical Control Format Indicator Channel (PCFICH), the Physical Hybrid-ARQ Indicator Channel (PHICH), the Physical Downlink Control Channel (PDCCH), or the like. The data may be carried on the Physical Downlink Shared Channel (PDSCH), for example. Base station transmit processor 620 may process (e.g., encode and symbol map) the data and control information to obtain data symbols and control symbols, respectively. Base station transmit processor 620 may also generate reference symbols, e.g., for the PSS, SSS, and cell-specific reference signal (RS). A base station transmit (TX) multiple-input multiple-output (MIMO) processor 630 may perform spatial processing (e.g., precoding) on the data symbols, the control symbols, and/or the reference symbols, if applicable, and may provide output symbol streams to base station modulators/demodulators (MODs/DEMODs) 632₁₋ₜ. Each base station modulator/demodulator 632 may process a respective output symbol stream (e.g., for orthogonal frequency-division multiplexing (OFDM), or the like) to obtain an output sample stream. Each base station modulator/demodulator 632 may further process (e.g., convert to analog, amplify, filter, and upconvert) the output sample stream to obtain a downlink signal. Downlink signals from modulators/demodulators 632₁₋ₜ may be transmitted via antennas 634₁₋ₜ, respectively.

At UE 615, UE antennas 652₁₋ᵣ may receive the downlink signals from base station 610 and may provide received signals to UE modulators/demodulators (MODs/DEMODs) 654₁₋ᵣ, respectively. Each UE modulator/demodulator 654 may condition (e.g., filter, amplify, downconvert, and digitize) a respective received signal to obtain input samples. Each UE modulator/demodulator 654 may further process the input samples (e.g., for OFDM, etc.) to obtain received symbols. A UE MIMO detector 656 may obtain received symbols from all UE modulators/demodulators 654₁₋ᵣ, and perform MIMO detection on the received symbols, if applicable, and provide detected symbols. A UE reception processor 658 may process (e.g., demodulate, deinterleave, and decode) the detected symbols, provide decoded data for UE 615 to a UE data sink 660, and provide decoded control information to a UE controller/processor 680.

On the uplink, at UE 615, a UE transmit processor 664 may receive and process data (e.g., for the Physical Uplink Shared Channel (PUSCH)) from a UE data source 662 and control information (e.g., for the Physical Uplink Control Channel (PUCCH)) from UE controller/processor 680. UE transmit processor 664 may also generate reference symbols for a reference signal. The symbols from UE transmit processor 664 may be precoded by a UE TX MIMO processor 666, if applicable, may be further processed by UE modulator/demodulators 654₁₋ᵣ (e.g., for SC-FDM, etc.), and may be transmitted to base station 610. At base station 610, the uplink signals from UE 615 may be received by base station antennas 634, processed by base station modulators/demodulators 632, detected by a base station MIMO detector 636, if applicable, and further processed by a base station reception processor 638 to obtain decoded data and control information sent by UE 615. Base station reception processor 638 may provide the decoded data to a base station data sink 646 and the decoded control information to base station controller/processor 640.

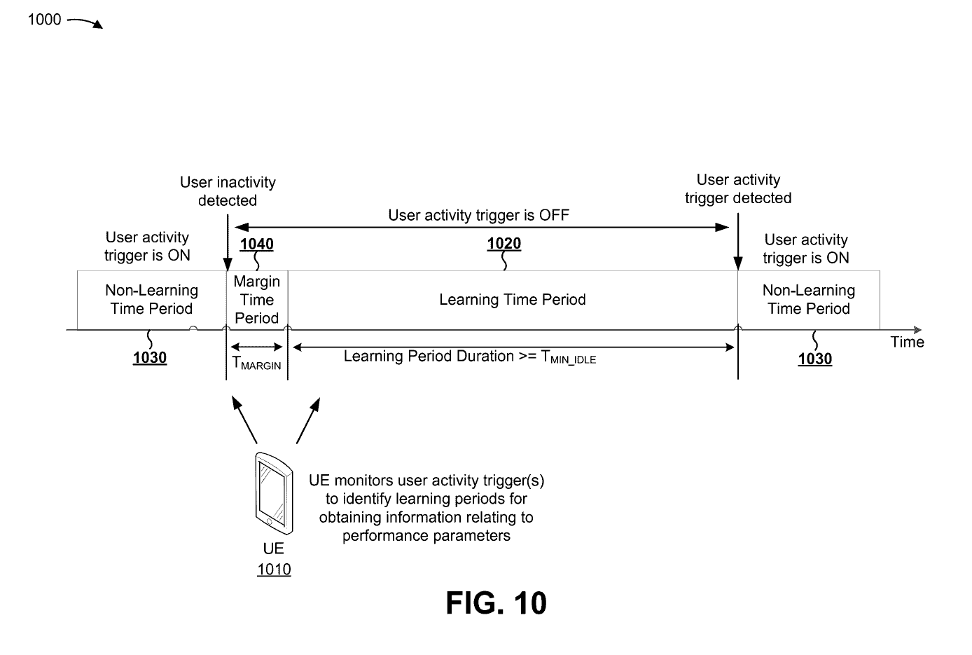

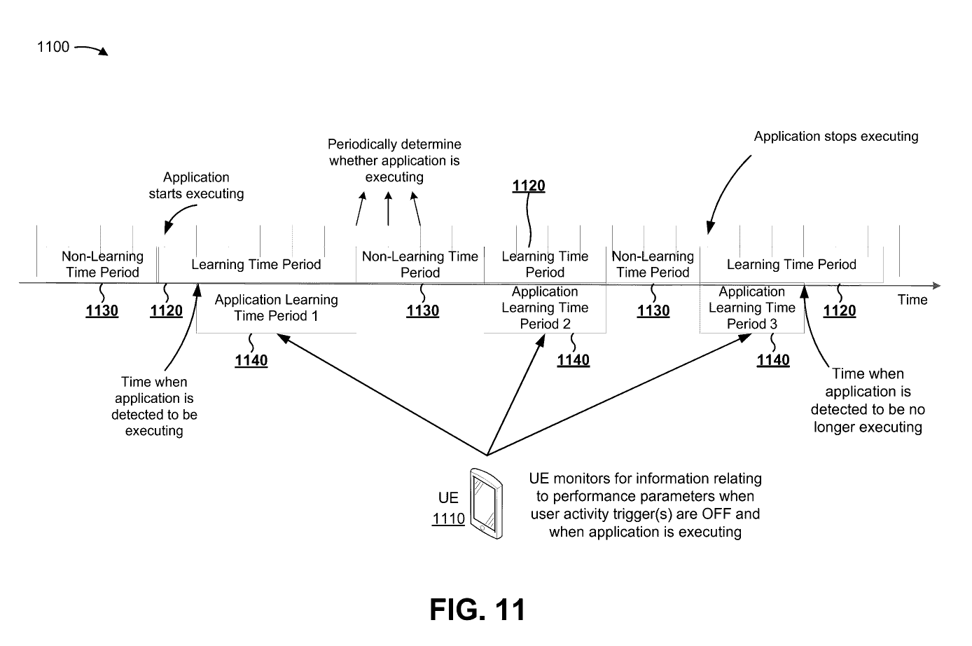

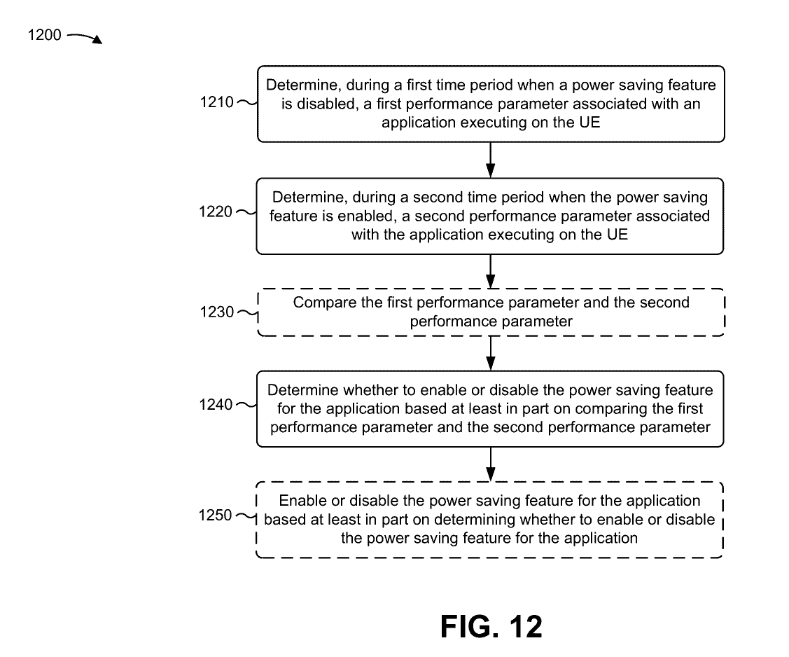

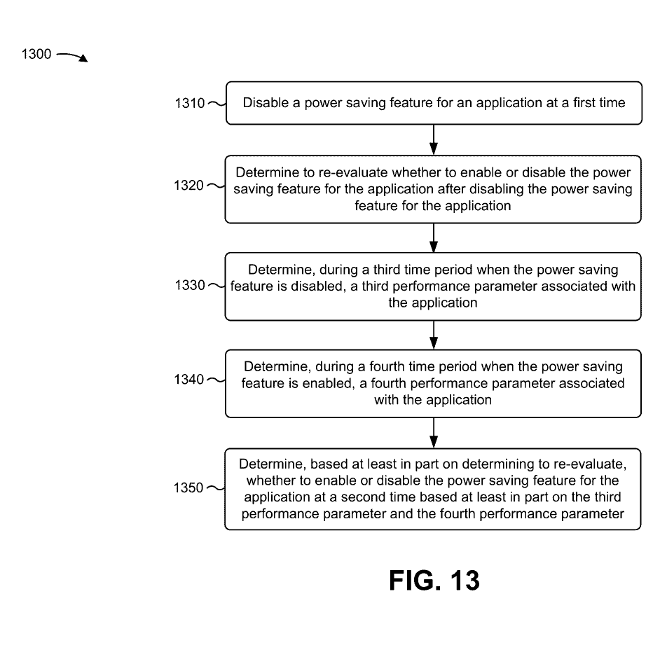

Base station controller/processor 640 and UE controller/processor 680 may direct the operation at base station 610 and UE 615, respectively. Base station controller/processor 640 and/or other processors and modules at base station 610 may perform or direct, for example, execution of various processes for the techniques described herein. UE controller/processor 680 and/or other processors and modules at UE 615 may also perform or direct, for example, execution of one or more blocks illustrated in FIG. 10, FIG. 11, FIG. 12, FIG. 13, and/or other processes for the techniques described herein. A base station memory 642 and a UE memory 682 may store data and program codes for base station 610 and UE 615, respectively. A scheduler 644 may schedule UEs 615 for data transmission on the downlink and/or uplink.

In one configuration, base station 610 may include means for generating a compact Downlink Control Information (DCI) for at least one of uplink (UL) or downlink (DL) transmissions, wherein the compact DCI comprises a reduced number of bits when compared to certain standard DCI formats; and means for transmitting the DCI. In one aspect, the aforementioned means may be base station controller/processor 640, base station memory 642, base station transmit processor 620, base station modulators/demodulators 632, and/or base station antennas 634 configured to perform the functions recited by the aforementioned means. In another aspect, the aforementioned means may be a module or any apparatus configured to perform the functions recited by the aforementioned means. In one configuration, UE 615 may include means for receiving compact Downlink Control Information (DCI) for at least one of uplink (UL) or downlink (DL) transmissions, wherein the DCI comprises a reduced number of bits of a standard DCI format; and means for processing the DCI. In one aspect, the aforementioned means may be UE controller/processor 680, UE memory 682, UE reception processor 658, UE MIMO detector 656, UE modulators/demodulators 654, and/or UE antennas 652 configured to perform the functions recited by the aforementioned means. In another aspect, the aforementioned means may be a module or any apparatus configured to perform the functions recited by the aforementioned means.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single components shown in FIG. 6 may be implemented as multiple, distributed components. Additionally, or alternatively, a set of components (e.g., one or more components) shown in FIG. 6 may perform one or more functions described as being performed by another set of components shown in FIG. 6.

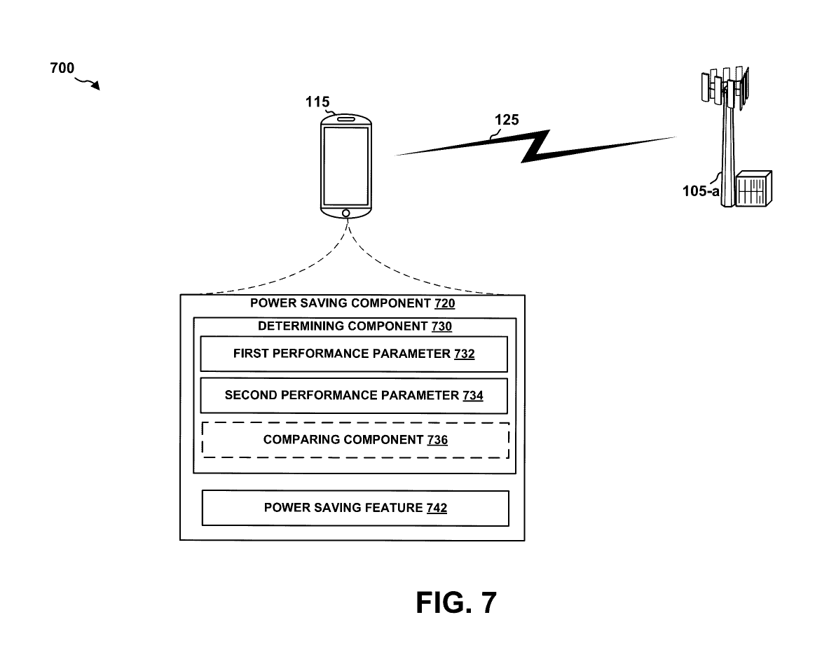

Referring to FIG. 7, in an aspect, a wireless communications system 700 (which may be the same as or similar to wireless communications system 100 of FIG. 1) includes at least one UE 115 in communication coverage of at least one base station 105-a. The base station 105-a (collectively referred to as Evolved Universal Mobile Telecommunications System (UMTS) Terrestrial Radio Access Network (E-UTRAN)) may interface with a core network (such as core network 130 of FIG. 1) through backhaul links 132 (e.g., 51 interface). In an aspect, UE 115 may include one or more processors (not shown) and, optionally, memory (not shown), that may operate in combination with power saving component 720 to dynamically enable or disable a user equipment power saving feature based on application performance. The wireless communications between UE 115 and base station 105-a may include signals transmitted by either the base station 105-a or the UE 115 via communication link 125, respectively. For example, with respect to the communication between UE 115 and base station 105-a, wireless communications may include one or more downlink channels transmitted by base station 105-a to UE 115, and one or more uplink channels transmitted by UE 115 to base station 105-a.

In an aspect, UE 115 and/or power saving component 720 includes determining component 730, which may be configured to determine during a first time period when a power saving feature 742 is disabled, a first performance parameter 732 associated with an application executing on the UE. Determining component 730 may be configured to determine during a second time period when the power saving feature 742 is enabled, a second performance parameter 734 associated with the application executing on the UE. Determining component 730 may be further configured to determine whether to enable or disable the power saving feature 742 for the application based at least in part on the first performance parameter 732 and the second performance parameter 734.

In an aspect, UE 115 and/or power saving component 720 includes comparing component 736, which may be configured to compare the first performance parameter 732 and the second performance parameter 734. For example, in determining whether to enable or disable the power saving feature, determining component 730 and/or comparing component 736 may compare the first performance parameter 732 and the second performance parameter 734. As a result of the comparison, determining component 730 and/or comparing component 736 may determine whether to enable or disable the power saving feature 742 based at least in part on comparing the first performance parameter 732 and the second performance parameter 734. As a result, of the comparison, determining component 730 may be configured to enable or disable the power saving feature 742 for the application.

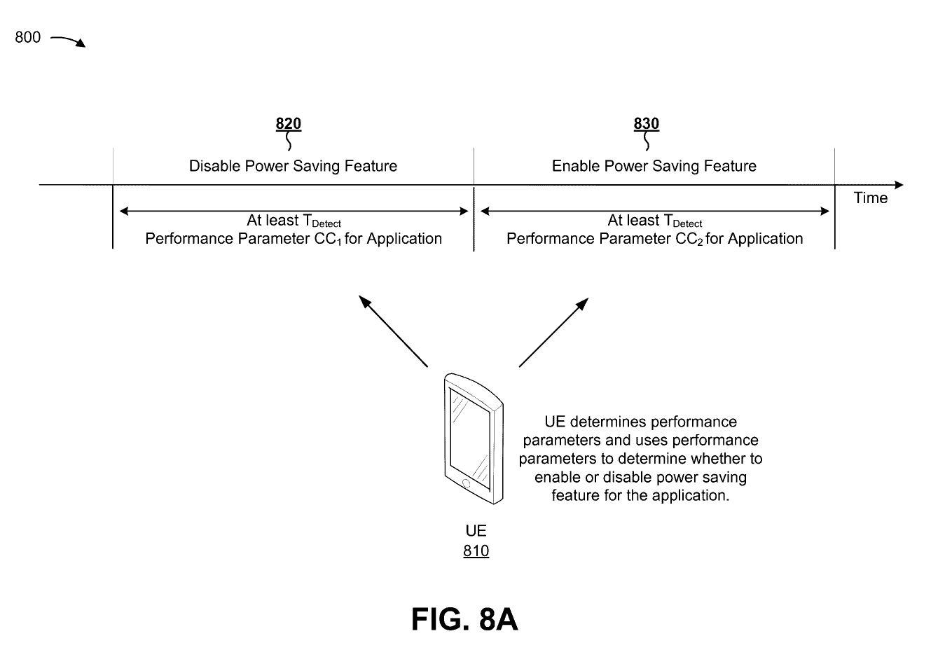

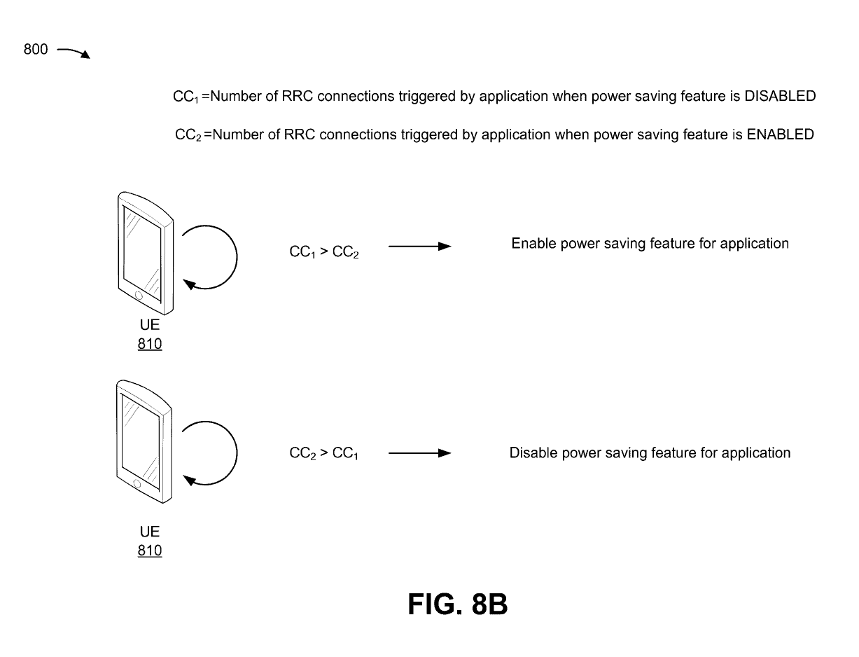

FIGS. 8A and 8B are diagrams illustrating an example 800 of determining whether to enable or disable a power saving feature for an application, in accordance with various aspects of the present disclosure.

As shown in FIG. 8A, a UE 810, may include a power saving component, such as power saving component 720 of FIG. 7. The power saving component 720 may determine whether to enable or disable a power saving feature for an application by measuring a first performance parameter (shown as CC₁) during a first time period 820 when the power saving feature is disabled and by measuring a second performance parameter (shown as CC₂) during a second time period 830 when the power saving feature is enabled. UE 810 may correspond to a UE described in connection with one or more other figures of the present disclosure. First time period 820 may be referred to herein as a disabled feature period 820. Similarly, second time period 830 may be referred to herein as an enabled feature period 830.

In some aspects, a power saving feature may refer to a mode of a power saving application (e.g., a Network Socket Request Manager (NSRM) application). For example, the power saving application may be operable in multiple modes, and the power saving features may refer to one of the modes. In this case, enabling or disabling the power saving feature may refer to enabling or disabling a mode of the power saving application. For example, UE 810 may enable or disable NSRM version 1, NSRM version 2, another version of NSRM, one or more modes of another power saving application, or the like.

As shown, during disabled feature period 820, UE 810 may determine a first performance parameter (CC₁) associated with an application executing on UE 810. The first performance parameter may indicate a power consumption associated with the application when the power saving feature is disabled for the application. For example, the first performance parameter may indicate a number of occurrences (e.g., in a time period or divided by an amount of time) that the application causes UE 810 to wake up or exit an idle mode (e.g., a DTX mode, a DRX mode, a radio resource control (RRC) idle mode, etc.), a number of times that the application causes UE 810 to enter an RRC connected mode, a number of RRC connections triggered by the application, or the like. In some cases, the first performance parameter may be referred to herein as a disabled feature parameter.

As further shown, during enabled feature period 830, UE 810 may determine a second performance parameter (CC₂) associated with an application executing on UE 810. The second performance parameter may indicate a power consumption associated with the application when the power saving feature is enabled for the application. For example, the second performance parameter may indicate a number of occurrences (e.g., in a time period or divided by an amount of time) that the application causes UE 810 to wake up or exit an idle mode (e.g., a DTX mode, a DRX mode, a radio resource control (RRC) idle mode, etc.), a number of times that the application causes UE 810 to enter an RRC connected mode, a number of RRC connections triggered by the application, or the like. In some cases, the second performance parameter may be referred to herein as an enabled feature parameter.

As shown, UE 810 may use the first performance parameter and/or the second performance parameter to determine whether to enable or disable the power saving feature for the application. For example, if the performance parameters indicate that less power is consumed when the power saving feature is enabled as compared to when the power saving feature is disabled, then UE 810 may enable the power saving feature for the application. Conversely, if the performance parameters indicate that more power is consumed when the power saving feature is enabled as compared to when the power saving feature is disabled, then UE 810 may disable the power saving feature for the application. Additional details regarding using the performance parameters to determine whether to enable or disable the power saving feature for an application are described below in connection with FIG. 8B.

As further shown in FIG. 8A, UE 810 may determine whether a duration of disabled feature period 820 satisfies a detection threshold (shown as T_{Detect}) before determining whether to enable or disable the power saving feature. For example, if the duration does not satisfy the detection threshold, then UE 810 may not have a large enough sample size of information to determine the disabled feature parameter (CC₂). If the duration satisfies the detection threshold, then UE 810 may have obtained enough information to determine the disabled feature parameter (CC₂). Thus, UE 810 may determine the disabled feature parameter based at least in part on determining that the disabled feature period satisfies a detection threshold.

Similarly, UE 810 may determine whether a duration of enabled feature period 830 satisfies a detection threshold (shown as T_{Detect}) before determining whether to enable or disable the power saving feature. The detection threshold for enabled feature period 830 may be the same as or different from the detection threshold for disabled feature period 820. UE 810 may determine the enabled feature parameter based at least in part on determining that the enabled feature period satisfies a detection threshold.

In some aspects, disabled feature period 820 and enabled feature period 830 may correspond to time periods during which a user is not actively using UE 810. For example, UE 810 may monitor UE 810 for one or more user activity triggers that indicate whether a user is actively using UE 810. A user activity trigger may include, for example, a trigger that indicates that a display of UE 810 is on, a trigger that indicates that user input is being provided to and/or received by UE 810 (e.g., keypad input, touch screen input, microphone input, etc.), a trigger that indicates that output intended for a user is being provided by UE 810 (e.g., speaker output, display output, etc.), a trigger that indicates that UE 810 is being used for tethering with another device, or the like. Additional details regarding user activity triggers are described below in connection with FIG. 10.

In some aspects, UE 810 may determine application-specific performance parameters. For example, UE 810 may determine a first disabled feature parameter and a first enabled feature parameter for a first application, may determine a second disabled feature parameter and a second enabled feature parameter for a second application, etc. In this way, UE 810 may enable or disable the power saving feature for different applications. For example, UE 810 may determine to enable the power saving feature for the first application, and may determine to disable the power saving feature for the second application. In this way, UE 810 may exercise fine-grained control to reduce power consumption by selectively enabling or disabling a power saving feature for different applications executing on UE 810.

As shown in FIG. 8B, and as an example, the first performance parameter (CC₁) may represent a number of RRC connections triggered by an application when the power saving feature is disabled. Similarly, the second performance parameter (CC₂) may represent a number of RRC connections triggered by an application when the power saving feature is enabled. In some aspects, UE 810 may compare the first performance parameter and the second performance parameter, and may determine whether to enable or disable the power saving feature for the application based at least in part on comparing the first performance parameter and the second performance parameter.

In some aspects, UE 810 may compare the performance parameters to determine whether the first performance parameter is greater than, less than, or equal to the second performance parameter. The UE 810 may use this comparison to determine whether to enable or disable the power saving feature for the application. Additionally, or alternatively, UE 810 may modify the first performance parameter and/or the second performance parameter using a weight value before performing the comparison. In this case, and as an example, UE 810 may compare a weighted first performance parameter and the second performance parameter. As another example, UE 810 may compare the first performance parameter and a weighted second performance parameter. As another example, UE 810 may compare a weighted first performance parameter and a weighted second performance parameter.

As an example, and as shown, the first performance parameter may be greater than the second performance parameter, in some aspects. This may indicate that the application triggered more RRC connections when the power saving feature was disabled, and that the application triggered fewer RRC connections when the power saving feature was enabled. Thus, the application consumed less power when the power saving feature was enabled. Therefore, UE 810 may enable the power saving feature for the application in order to reduce power consumption.

As another example, and as shown, the second performance parameter may be greater than the first performance parameter, in some aspects. This may indicate that the application triggered more RRC connections when the power saving feature was enabled, and that the application triggered fewer RRC connections when the power saving feature was disabled. Thus, the application consumed less power when the power saving feature was disabled. Therefore, UE 810 may disable the power saving feature for the application in order to reduce power consumption.

The number of RRC connections triggered by the application is used as the performance parameter in FIG. 8B as an example. In practice, other performance parameters may be used, as described elsewhere herein. Furthermore, a direct comparison of the performance parameters is shown in FIG. 8B as an example. In practice, the performance parameters may be compared to one another and/or to other values in a different manner than shown. As an example, if both the first performance parameter and the second performance parameter are less than a threshold performance parameter value (e.g., a configurable value, then UE 810 may enable the power saving feature. As another example, UE 810 may modify the first performance parameter and/or the second performance parameter using a weight value (e.g., a different weight value), and may compare the modified performance parameter(s) to determine whether to enable or disable the power saving feature for the application. Additionally, or alternatively, one or more parameters described herein may be mathematically combined with one or more other parameters and/or constant values, and the resulting value(s) may be used for a comparison.

As indicated above, FIGS. 8A and 8B are provided as an example. Other examples are possible and may differ from what was described in connection with FIGS. 8A and 8B.

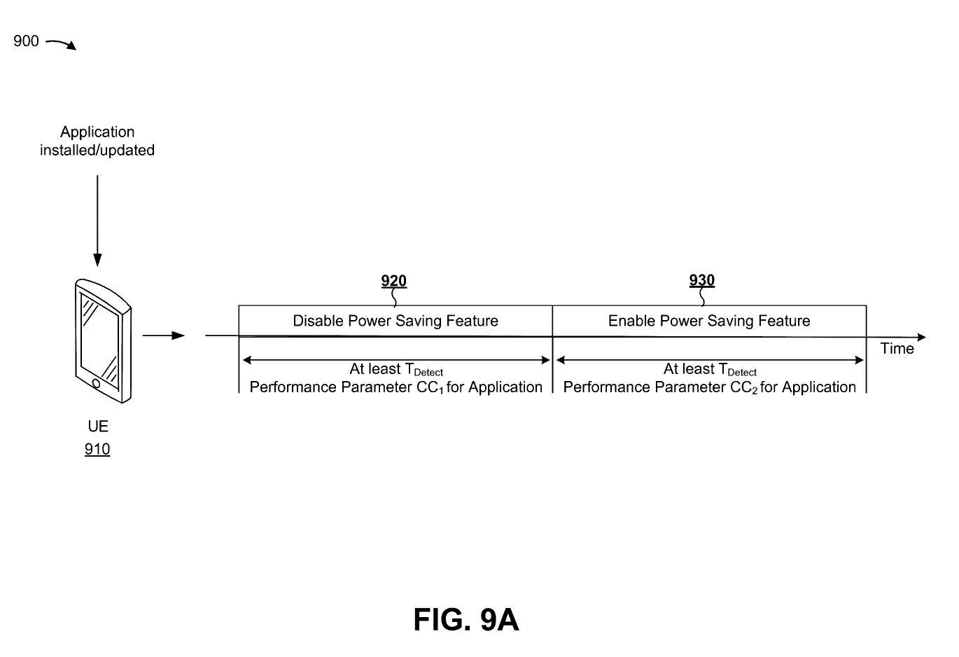

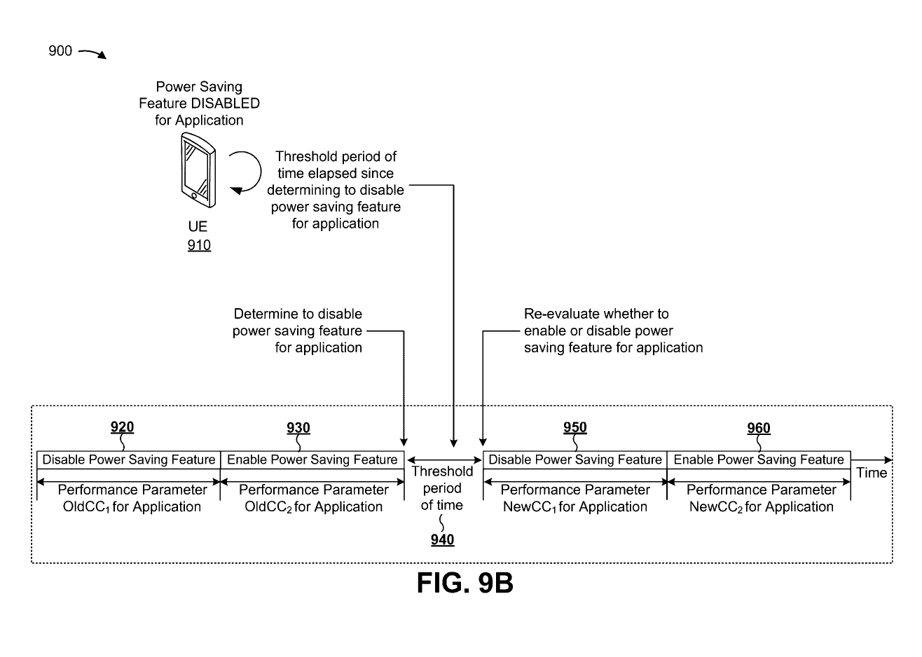

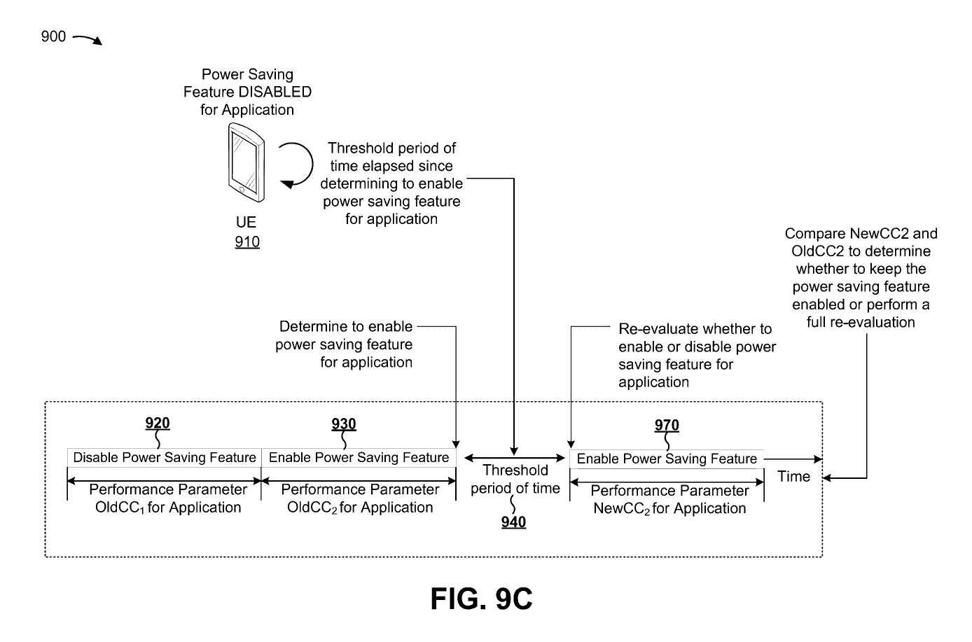

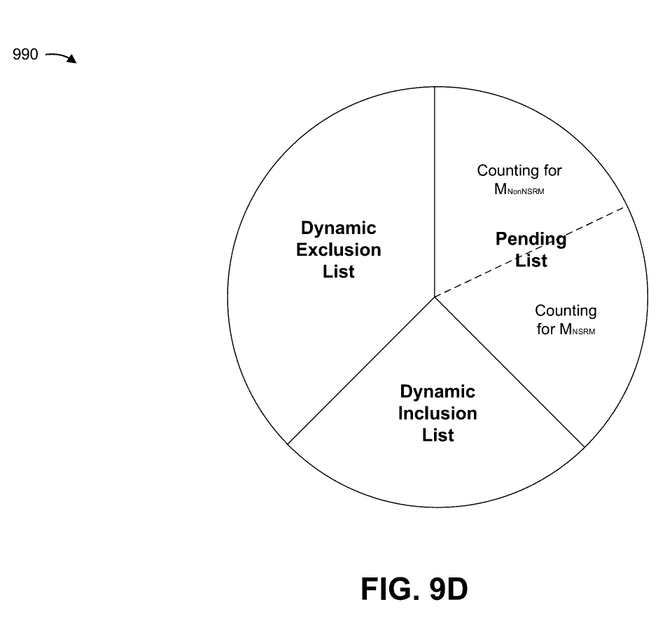

FIGS. 9A-9C are diagrams illustrating an example 900 of triggering an evaluation and a re-evaluation of whether to enable or disable a power saving feature for an application, in accordance with various aspects of the present disclosure.

As shown in FIG. 9A, a UE 910, may include a power saving component, such as power saving component 720 of FIG. 7. The power saving component 720 may detect that an application has been installed or updated on UE 910. UE 910 may correspond to a UE described in connection with one or more other figures of the present disclosure. Based at least in part on detecting that the application has been installed or updated, UE 910 may evaluate whether to enable or disable a power saving feature for the application.

For example, and as shown, UE 910 may determine that an application has been downloaded or updated. Based at least in part on this determination, UE 910 may determine a first performance parameter (CC₁) during a first time period 920 when the power saving feature is disabled for the application, and may determine a second performance parameter (CC₂) during a second time period 930 when the power saving feature is enabled. In some aspects, first time period 920 may correspond to first time period 820 (e.g., disabled feature period 820), and second time period 930 may correspond to second time period 830 (e.g., enabled feature period 830).

UE 910 may determine whether to enable or disable the power saving feature for the application based at least in part on the first performance parameter (e.g., a disabled feature parameter) and the second performance parameter (e.g., an enabled feature parameter), as described elsewhere herein. In this way, when a new application is installed on UE 910, UE 910 may evaluate whether to enable or disable the power saving feature for the application in order to conserve power. Additionally, or alternatively, when an application is updated, a behavior of the application may change with respect to the power saving feature. Thus, UE 910 may evaluate whether to enable or disable the power saving feature for the updated application in order to conserve power.

As shown in FIG. 9B, the UE 910 may disable the power saving feature for the application at a first time (e.g., based at least in part on the evaluation described in connection with FIG. 9A). At a later time, UE 910 may re-evaluate whether to enable or disable the power saving feature for the application. For example, UE 910 may determine that a threshold period of time 940 (e.g., an evaluation threshold) has elapsed since performing a previous evaluation, since determining to disable the power saving feature for the application, or the like. As another example, UE 910 may re-evaluate whether to enable or disable the power saving feature based at least in part on a determination that the threshold period of time 940 has elapsed and that the application has been updated since the previous evaluation.

As an example, and as shown, if the power saving feature is disabled for the application, UE 910 may perform the re-evaluation by determining a third performance parameter associated with the application during a third time period 950 when the power saving feature is disabled. Furthermore, UE 910 may perform the re-evaluation by determining a fourth performance parameter associated with the application during a fourth time period 960 when the power saving feature is enabled.

In some aspects, the third performance parameter (NewCC₁) may correspond to the first performance parameter (OldCC₁), described above. In this case, the first performance parameter may be referred to as a first disabled feature parameter, and the third performance parameter may be referred to as a second disabled feature parameter, because these performance parameters are determined during a time period when the power saving feature is disabled. Similarly, the fourth performance parameter (NewCC₂) may correspond to the second performance parameter (OldCC₂), described above. In this case, the second performance parameter may be referred to as a first enabled feature parameter, and the fourth performance parameter may be referred to as a second enabled feature parameter, because these performance parameters are determined during a time period when the power saving feature is enabled.

In some aspects, the third time period 950 may correspond to the first time period 920. In this case, the first time period 920 may be referred to as a first disabled feature period 920, and the third time period 950 may be referred to as a second disabled feature period 950, because the power saving feature is disabled during these time periods. Similarly, the fourth time period 960 may correspond to the second time period 930. In this case, the second time period 930 may be referred to as a first enabled feature period 930, and the fourth time period 960 may be referred to as a second enabled feature period 950, because the power saving feature is enabled during these time periods.

UE 910 may determine whether to enable or disable the power saving feature for the application at a second time based at least in part on the third performance parameter and the fourth performance parameter, in a similar manner as described above in connection with the first performance parameter and the second performance parameter. For example, UE 910 may compare the third performance parameter (NewCC₁) and the fourth performance parameter (NewCC₂), and may determine whether to enable or disable the power saving feature for the application based at least in part on comparing the third performance parameter and the fourth performance parameter.

In this way, UE 910 may re-evaluate whether enabling or disabling the power saving feature for the application conserves power. For example, a condition associated with UE 910 may change over time, such as a behavior of the application (e.g., due to an update), a behavior of the power saving feature (e.g., due to an update), a behavior of UE 910, a behavior of an application server associated with the application, or the like. By periodically re-evaluating whether enabling or disabling the power saving feature for the application conserves power, UE 910 may enhance the performance of UE 910, the application, and/or the power saving feature.

As shown in FIG. 9C, UE 910 may enable the power saving feature for the application at a first time (e.g., based at least in part on the evaluation described in connection with FIG. 9A). At a later time, UE 910 may re-evaluate whether to enable or disable the power saving feature for the application, as described above in connection with FIG. 9B. For example, UE 910 may determine that a threshold period of time 940 (e.g., an evaluation threshold) has elapsed since performing a previous evaluation, since determining to disable the power saving feature for the application, or the like. As another example, UE 910 may re-evaluate whether to enable or disable the power saving feature based at least in part on a determination that the threshold period of time 940 has elapsed and that the application has been updated since the previous evaluation.

As an example, and as shown, if the power saving feature is enabled for the application, UE 910 may perform the re-evaluation by determining a performance parameter (NewCC₂) associated with the application during a time period 970 when the power saving feature is enabled. In some aspects, this performance parameter may correspond to the second enabled feature parameter (NewCC₂), described above in connection with FIG. 9B. Additionally, or alternatively, time period 970 may correspond to the second enabled feature period 950, described above in connection with FIG. 9B.

UE 910 may determine whether to enable or disable the power saving feature for the application at a second time based at least in part on the first enabled feature parameter (Old CC₂) and the second enabled feature parameter (New CC₂). For example, UE 910 may compare the first enabled feature parameter (Old CC₂) and the second enabled feature parameter (New CC₂), and may determine whether to enable or disable the power saving feature for the application based at least in part on the comparison.

In some aspects, UE 910 may determine whether to keep the power saving feature enabled or to perform a full re-evaluation based at least in part on comparing the first enabled feature parameter (OldCC₂) and the second enabled feature parameter (NewCC₂). For example, if NewCC₂ is less than OldCC₂, this may indicate that the power saving feature consumed less power when enabled during the re-evaluation as compared to the amount of power consumed when enabled during a previous evaluation. Thus, in this case, UE 910 may keep the power saving feature enabled for the application.

As another example, if NewCC₂ is greater than OldCC₂, this may indicate that the power saving feature consumed more power when enabled during the re-evaluation as compared to the amount of power consumed when enabled during a previous evaluation. In this case, UE 910 may perform a full re-evaluation to determine whether to enable or disable the power saving feature for the application. A full re-evaluation may correspond to the example described in connection with FIG. 9B, where UE 910 determines a second disabled feature parameter (NewCC₁) during a second disabled feature period, determines a second enabled feature parameter (NewCC₂) during a second enabled feature period, and compares the second disabled feature parameter and the second enabled feature parameter to determine whether to enable or disable the power saving feature for the application.

In this way, when UE 910 has determined that enabling the power saving feature conserves power based at least in part on an initial evaluation (e.g., described in connection with FIG. 9A), UE 910 may conserve computing resources by performing a partial re-evaluation to determine whether to keep the power saving feature enabled (e.g., described in connection with FIG. 9C). If, however, UE 910 has determined that disabling the power saving feature conserves power based at least in part on an initial evaluation (e.g., described in connection with FIG. 9A), UE 910 may perform a full re-evaluation to determine whether to enable or disable the power saving feature for the application (e.g., described in connection with FIG. 9B).

As indicated above, FIGS. 9A-9C are provided as an example. Other examples are possible and may differ from what was described in connection with FIGS. 9A-9C.

FIG. 9D is a diagram illustrating a chart diagram 990 for establishing one or more lists of applications used to determine whether to enable or disable a power saving feature for an application.

As shown in FIG. 9D, the UE, such as UE 115 (FIG. 7) may be configured with a power saving component, such as power saving component 720 (FIG. 7), which may maintain three lists: dynamic inclusion list, dynamic exclusion list, and pending list. For example, dynamic inclusion list may correspond to a list of applications that are identified by the power saving component to be searched in order determine whether to dynamically enabling or disabling a user equipment power saving feature. Dynamic exclusion list may correspond to a list of applications that are identified by the power saving component to be installed for the first time or that the application has been updated; and that the applications are currently in the dynamic inclusion list or that the applications are not currently in the dynamic exclusion list. Pending list may correspond to a list of applications that are identified by the power saving component to not be searched in order determine whether to dynamically enabling or disabling a user equipment power saving feature. In an aspect, for example, the power savings component may run a detecting algorithm for the applications in the pending list for determining whether to dynamically enabling or disabling a user equipment power saving feature. The initial pending list may include all applications that are included in the dynamic inclusion list and/or all applications not included in the dynamic exclusion list. Furthermore, the UE may place an application into the pending list based on a determining that the application is installed for the first time or that the application has been updated; and that the application is currently in the dynamic inclusion list or that the application is not currently in the dynamic exclusion list. Moreover, the UE may move the application to either the dynamic inclusion list or the dynamic exclusion list based on the result of the determination as well.

Additionally, the UE may synchronize a packet if its source application is currently in the dynamic inclusion list or not in the dynamic exclusion list; and that the source application is in the dynamic inclusion list, or the pending list along with counting for M_{NSRM}, wherein NSRM corresponds to a Network Socket Request Manager of the UE. In an aspect, each application may maintain two variables: NSRM Working Mode and NSRM Learning Algorithm Concluded. For example, the NSRM Working Mode (ActiveMode) may correspond to the current MSRM mode applied to the application. Possible values for the NSRM Working Mode may include at least one of none, NSRM 1.0, or NSRM 2.0. In another example, the NSRM Learning Algorithm Concluded (IsConcluded) may correspond to indicating whether a decision has been made for the application, and the possible values may be either true or false. In an aspect, when any socket call is captured the power saving component may check the value of the NSRM Working Mode of the corresponding UID, and then may determine whether to synchronize the call. Synchronizing the data/packet allows the UE to save the data to reuse after reboot of the UE.

FIG. 10 is a diagram illustrating an example 1000 of determining a learning time period during which to monitor for information relating to performance parameters associated with determining whether to enable or disable a power saving feature for an application, in accordance with various aspects of the present disclosure.

As shown in FIG. 10, a UE 1010, may include a power saving component, such as power saving component 720 of FIG. 7. The power saving component 720 may monitor one or more user activity triggers to identify a learning time period 1020 for obtaining information relating to one or more performance parameters described herein. UE 1010 may correspond to a UE described in connection with one or more other figures of the present disclosure. Learning time period 1020 may correspond to a time period, multiple time periods, or a portion of a time period during which UE 1010 obtains information to determine a performance parameter described herein, such as a disabled feature time period, an enabled feature time period, or the like.

In some aspects, learning time period 1020 may include a time period during which a user is not actively using UE 1010. For example, UE 1010 may monitor UE 1010 for one or more user activity triggers that indicate whether a user is actively using UE 1010. A user activity trigger may include, for example, a trigger that indicates that a display of UE 1010 is on, a trigger that indicates that user input is being provided to and/or received by UE 1010 (e.g., keypad input, touch screen input, microphone input, etc.), a trigger that indicates that output intended for a user is being provided by UE 1010 (e.g., speaker output, display output, etc.), a trigger that indicates that UE 1010 is being used for tethering with another device, a trigger that indicates that UE 1010 has an IP address configured for a network (e.g., a WLAN, a peer-to-peer network, etc.), a trigger that indicates that a personal area network (e.g., Bluetooth) is being used by UE 1010, a trigger that indicates that UE 1010 is connected to another device (e.g., via a high definition media interface (HDMI), a universal serial bus (USB) interface, etc.), a trigger that indicates that a global positions system of UE 1010 is on, a trigger that indicates that an emergency alert has been received by UE 1010, or the like. In some aspects, learning time period 1020 may be a time period where every user activity trigger is off (e.g., false).

UE 1010 may monitor for information relating to a performance parameter when a user is not actively using UE 1010. In this way, UE 1010 may determine a performance parameter based at least in part on events triggered by an application, and not by events triggered by user activity. In this way, UE 1010 may be able to make a fair comparison between performance of an application with a power saving feature enabled and disabled without user activity interfering with the performance.

As further shown in FIG. 10, UE 1010 may differentiate between a learning time period 1020 and a non-learning time period 1030. For example, learning time period 1020 may correspond to a time period during which one or more user activity triggers are off (e.g., user activity is not detected), and non-learning time period 1030 may correspond to a time period during which one or more user activity triggers are on (e.g., user activity is detected). UE 1010 may monitor for information relating to a performance parameter during learning time period 1020, and may not monitor for information relating to a performance parameter during non-learning time period 1030.

In some aspects, UE 1010 may detect that a non-learning time period 1020 has ended. For example, UE 1010 may detect user inactivity, such as by determining that one or more user activity triggers are off. In some aspects, UE 1010 may wait for a threshold amount of time, shown as margin time period 1040 (T_{MARGIN}), after the non-learning time period 1020 ends, before monitoring for information relating to a performance parameter. In this way, UE 1010 may permit applications to finish performing actions related to user activity (e.g., to cool down), which may interfere with application performance, before monitoring for the performance parameter.

As an example, UE 1010 may determine that a non-learning time period 1030 has ended, may begin counting a margin time period 1040, and may begin a learning time period 1020 when the margin time period 1040 expires. To begin the learning time period 1020, UE 1010 may enable or disable the power saving feature for an application, and may monitor for information relating to an enabled feature parameter or a disabled feature parameter. For example, when learning time period 1020 corresponds to a disabled feature period or a portion of a disable feature period, UE 1010 may disable the power saving feature for the application, and may monitor for information relating to a disabled feature parameter (e.g., may count a number of times UE 1010 exits an idle mode, a number of RRC connections triggered by the application, etc.). As another example, when learning time period 1020 corresponds to an enabled feature period or a portion of an enabled feature period, UE 1010 may enable the power saving feature for the application, and may monitor for information relating to an enabled feature parameter.

In some aspects, UE 1010 may determine whether a duration of learning time period 1020 satisfies a minimum threshold (shown as T_{MIN}_{_}_{IDLE}). If the duration of learning time period 1020 is too short (e.g., less than the minimum threshold), UE 1010 may not detect any information relating to a performance parameter (e.g., a UE wake-up, an RRC connection, etc.), which may result in an inaccurate performance parameter. Thus, if the duration of learning time period 1020 does not satisfy the minimum threshold, then UE 1010 may not use any information obtained during learning time period 1020 to calculate a performance parameter. If the duration of learning time period 1020 satisfies the minimum threshold, then UE 1010 may use information obtained during learning time period 1020 to calculate a performance parameter.

Additionally, or alternatively, if the duration of learning time period 1020 does not satisfy the minimum threshold, then UE 1010 may not count the duration toward a detection threshold (T_{Detect}), described above in connection with FIG. 7A. If the duration of learning time period 1020 satisfies the minimum threshold, then UE 1010 may count the duration toward the detection threshold (T_{Detect}). In some aspects, UE 1010 may use several segments of learning time to contribute to T_{Detect}. While combining the time periods, UE 1010 may combine the performance parameter (e.g., a number of RRC connections, or the like).

In this way, UE 1010 may ensure that performance parameters are determined based at least in part on information obtained during time periods when a user is not actively using UE 1010, during time periods when applications have finished performing actions based on user activity, and/or during time periods that are of sufficient duration to obtain meaningful information. Additionally, or alternatively, UE 1010 may ensure that performance parameters for an application are determined during time periods when the application is executing, as described below in connection with FIG. 10.

As indicated above, FIG. 10 is provided as an example. Other examples are possible and may differ from what was described in connection with FIG. 10.

FIG. 11 is a diagram illustrating an example 1100 of determining a learning time period for an application based at least in part on determining whether the application is executing, in accordance with various aspects of the present disclosure.

As shown in FIG. 11, a UE 1110, may include a power saving component, such as power saving component 720 of FIG. 7. The power saving component 720 may monitor for information relating to one or more performance parameters for an application when a user is not actively using UE 1110 and when the application is executing on UE 1110. UE 1110 may correspond to a UE described in connection with one or more other figures of the present disclosure. As further shown in FIG. 11, UE 1110 may identify one or more learning time periods 1120 and/or one or more non-learning time periods 1130, as described elsewhere herein. For example, learning time period 1120 may correspond to learning time period 920, described above in connection with FIG. 10. Additionally, or alternatively, non-learning time period 1130 may correspond to non-learning time period 930, described above in connection with FIG. 10.

In some aspects, learning time period 1120 may include an application learning time period 1140 during which an application, for which a performance parameter is to be determined, is executing on UE 1110. For example, UE 1110 may periodically monitor UE 1110 and/or the application to determine whether the application is executing (e.g., during learning time period 1120). For example, UE 1110 may periodically query the status of one or more applications (e.g., at a set interval, at a random interval, etc.). An application learning time period 1140 may begin when a user is not actively using UE 1110 (e.g., during learning time period 1120, based on user activity trigger(s) described above in connection with FIG. 10) and when the application is executing on UE 1110 (e.g., when UE 1110 detects that the application is executing).

In some aspects, application learning time period 1140 may begin when the application has been executing on UE 1110 for a threshold amount of time (e.g., an execution threshold). For example, UE 1110 may determine that a user is not actively using UE 1110, and may determine that the application has been executing on UE 1110 for a threshold amount of time. Based at least in part on these determinations, UE 1110 may monitor for information relating to one or more performance parameters associated with the application, as described elsewhere herein. In this way, UE 1110 may determine whether to enable or disable a power saving feature for an application by monitoring the application when the application is executing. Otherwise, if the application were not executing, UE 1110 may not have relevant information to determine whether to enable or disable the power saving feature for the application.

In some aspects, application learning time period 1140, for the application, may end when the application stops executing on UE 1110. Additionally, or alternatively, application learning time period 1140 may end when a user is actively using UE 1110 (e.g., when learning time period 1120 ends). For example, UE 1110 may determine that a user is actively using UE 1110, or may determine that the application has stopped executing on UE 1110. Based on at least one of these determinations, UE 1110 may stop monitoring for information relating to one or more performance parameters associated with the application, as described elsewhere herein. In this way, UE 1110 may determine whether to enable or disable a power saving feature for an application by monitoring the application when the application is executing.

As indicated above, FIG. 11 is provided as an example. Other examples are possible and may differ from what was described in connection with FIG. 11.

FIG. 12 is a flow diagram of an example process 1200 for determining whether to enable or disable a power saving feature for an application, in accordance with various aspects of the present disclosure. In some aspects, one or more process blocks of FIG. 12 may be performed by one or more UEs described herein. In some aspects, one or more process blocks of FIG. 12 may be performed by another device or a plurality of devices separate from or including a UE.

As shown in FIG. 12, process 1200 may include determining, during a first time period when a power saving feature is disabled, a first performance parameter associated with an application executing on a UE (block 1210). For example, in an aspect, power saving component 720 and/or determining component 730 may determine a first performance parameter associated with an application executing on the UE. The power saving component 720, and/or determining component 730 may determine the first performance parameter during a first time period when a power saving feature is disabled for the application. In some aspects, the first performance parameter may be referred to as a disabled feature parameter because the first performance parameter is determined during a time period when the power saving feature is disabled. In some aspects, the power saving feature may be a mode of a power saving application (e.g., of a plurality of modes). In this case, the UE and/or the determining component 730 may disable the mode during the first time period.

The first performance parameter may include, for example, a number of times that the UE exits an idle mode (e.g., a number of times that the application causes the UE to exit the idle mode), a number of times that the UE enters an RRC connected mode (e.g., a number of times that the application causes the UE to enter the RRC connected mode), a number of RRC connections triggered by the application, a number of messages received (e.g., test messages periodically sent to a server to verify connectivity), or the like. In some aspects, the UE may use a combination of the above parameters or other parameters. Additionally, or alternatively, the UE and/or power saving component 720 may select a parameter to use based at least in part on a pre-configuration, information received from another device (e.g., an eNB), a type of application, or the like.

In some aspects, the power saving component 720 and/or determining component 730 may determine that a duration of the first time period satisfies a threshold, and may determine the first performance parameter based at least in part on determining that the duration of the first time period satisfies the threshold. Additionally, or alternatively, the first time period may include a time period during which a user is not actively using the UE.

In some aspects, the first time period may include at least one learning time period during which a user is not actively using the UE. In some aspects, the learning time period may begin after expiration of a margin time period. The margin time period may begin after detecting that the user is not actively using the UE. In some aspects, a duration of the learning time period may satisfy a threshold. In some aspects, the power saving component 720 and/or determining component 730 may periodically determine whether the application is executing during the learning time period. Additionally, or alternatively, the application may be executing during the first time period. Additionally, or alternatively, the first time period may include a plurality of time periods during which a user is not actively using the UE and during which the application is executing on the UE.

In some aspects, the power saving component 720 and/or determining component 730 may determine that a user is not actively using the UE, and may determine that the application has been executing one the UE for a threshold amount of time. Based at least in part on one or both of these determinations, the UE may monitor for information relating to the first performance parameter. The UE may determine the first performance parameter based at least in part on monitoring for the information relating to the first performance parameter. In some aspects, the UE may determine that the user is actively using the UE or that the application has stopped executing on the UE. Based at least in part on one or both of these determinations, the UE may stop monitoring for the information relating to the first performance parameter.

As shown in FIG. 12, process 1200 may include determining, during a second time period when the power saving feature is enabled, a second performance parameter associated with the application executing on the UE (block 1220). For example, in an aspect, power saving component 720 and/or determining component 730 may determine a second performance parameter associated with an application executing on the UE. The UE may determine the second performance parameter during a second time period when a power saving feature is enabled for the application. In some aspects, the second performance parameter may be referred to as an enabled feature parameter because the second performance parameter is determined during a time period when the power saving feature is enabled. In some aspects, the power saving feature may be a mode of a power saving application (e.g., of a plurality of modes). In this case, the UE and/or determining component 730 may enable the mode during the first time period.

The second performance parameter may include, for example, a number of times that the UE exits an idle mode (e.g., a number of times that the application causes the UE to exit the idle mode), a number of times that the UE enters an RRC connected mode (e.g., a number of times that the application causes the UE to enter the RRC connected mode), a number of RRC connections triggered by the application, or the like. In some aspects, the UE may use a combination of the above parameters or other parameters. Additionally, or alternatively, the power saving component 720 and/or determining component 730 may select a parameter to use based at least in part on a pre-configuration, information received from another device (e.g., an eNB), a type of application, or the like. In some aspects, the power saving component 720 and/or determining component 730 may use a same type of parameter for the first performance parameter and the second performance parameter (e.g., so that the same type of parameter is compared).

In some aspects, power saving component 720 and/or determining component 730 may determine that a duration of the second time period satisfies a threshold, and may determine the second performance parameter based at least in part on determining that the duration of the second time period satisfies the threshold. Additionally, or alternatively, the second time period may include a time period during which a user is not actively using the UE.

In some aspects, the second time period may include at least one learning time period during which a user is not actively using the UE. In some aspects, the learning time period may begin after expiration of a margin time period. The margin time period may begin after detecting that the user is not actively using the UE. In some aspects, a duration of the learning time period may satisfy a threshold. In some aspects, power saving component 720 and/or determining component 730 may periodically determine whether the application is executing during the learning time period. Additionally, or alternatively, the application may be executing during the second time period. Additionally, or alternatively, the second time period may include a plurality of time periods during which a user is not actively using the UE and during which the application is executing on the UE.

In some aspects, power saving component 720 and/or determining component 730 may determine that a user is not actively using the UE, and may determine that the application has been executing one the UE for a threshold amount of time. Based at least in part on one or both of these determinations, the UE may monitor for information relating to the second performance parameter. The power saving component 720 and/or determining component 730 may determine the second performance parameter based at least in part on monitoring for the information relating to the second performance parameter. In some aspects, power saving component 720 and/or determining component 730 may determine that the user is actively using the UE or that the application has stopped executing on the UE. Based at least in part on one or both of these determinations, the UE may stop monitoring for the information relating to the second performance parameter.

As shown in FIG. 12, process 1200 may include comparing the first performance parameter and the second performance parameter (block 1230). For example, in an aspect, power saving component 720 and/or comparing component 736 may compare the first and second performance parameters. In some aspects, power saving component 720 and/or comparing component 736 may compare the performance parameters to determine whether the first performance parameter is greater than, less than, or equal to the second performance parameter. The UE and/or comparing component 736 may use this comparison to determine whether to enable or disable the power saving feature for the application.

In some aspects, power saving component 720 and/or comparing component 736 may modify the first performance parameter and/or the second performance parameter using a weight value before performing the comparison. In this case, and as an example, power saving component 720 and/or comparing component 736 may compare a weighted first performance parameter and the second performance parameter. As another example, power saving component 720 and/or comparing component 736 may compare the first performance parameter and a weighted second performance parameter. As another example, the UE may compare a weighted first performance parameter and a weighted second performance parameter.

As shown in FIG. 12, process 1200 may include determining whether to enable or disable the power saving feature for the application based at least in part on comparing the first performance parameter and the second performance parameter (block 1240). For example, in an aspect, power saving component 720 and/or comparing component 736 may compare the first and second performance parameters, and may use this comparison to determine whether to enable or disable the power saving feature for the application. Additionally, or alternatively, the UE may report a result of the comparison to a server.

Additionally, or alternatively, in an aspect, power saving component 720 and/or comparing component 736 may determine whether to enable or disable the power saving feature for the application based at least in part on the first performance parameter and the second performance parameter (e.g., without comparing the first and second performance parameters to one another). For example, the UE and/or comparing component 736 may compare the first and second performance parameters to a threshold, and determining component 730 may determine whether to enable or disable the power saving feature for the application based at least in part on comparing the first and second performance parameters to a threshold.

In some aspects, the UE may evaluate whether to enable or disable the power saving feature for an application based at least in part on detecting that the application has been installed or updated on the UE. For example, the UE and/or power saving component 720 may detect that the application has been installed or updated on the UE. Based at least in part on this detection, power saving component 720 and/or comparing component 736 may determine the first performance parameter and the second performance parameter, and may determine whether to enable or disable the power saving feature for the application based at least in part on the first performance parameter and the second performance parameter.

Additionally, or alternatively, in an aspect, power saving component 720 and/or comparing component 736 may evaluate whether to enable or disable the power saving feature for an application based at least in part on determining that a threshold period of time has elapsed since a prior determination of whether to enable or disable the power saving feature. For example, power saving component 720 and/or comparing component 736 may determine that the period of time has elapsed. Based at least in part on this determination, power saving component 720 and/or comparing component 736 may determine the first performance parameter and the second performance parameter, and may determine whether to enable or disable the power saving feature for the application based at least in part on the first performance parameter and the second performance parameter.

As shown in FIG. 12, process 1200 may include enabling or disabling, by the UE, the power saving feature for the application based at least in part on determining whether to enable or disable the power saving feature for the application (block 1250). For example, in an aspect, power saving component 720 and/or determining component 730 may enable the power saving feature for the application based at least in part on determining whether to enable or disable the power saving feature for the application. As another example, power saving component 720 and/or determining component 730 may disable the power saving feature for the application based at least in part on determining whether to enable or disable the power saving feature for the application. In some aspects, power saving component 720 and/or determining component 730 may enable the power saving feature for a first application during a time period, and may disable the power saving feature for a second application during the time period.

In this way, the UE and/or power saving component 720 may dynamically determine whether to enable or disable a power saving feature for an application based at least in part on application performance. By selectively enabling or disabling the power saving feature for different applications based on performance, the UE may reduce power consumption and conserve power.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a flow diagram of an example process 1300 for re-evaluating whether to enable or disable a power saving feature for an application after the power saving feature has been disabled for the application, in accordance with various aspects of the present disclosure. In some aspects, one or more process blocks of FIG. 13 may be performed by one or more UEs described herein. In some aspects, one or more process blocks of FIG. 13 may be performed by another device or a plurality of devices separate from or including a UE.

As shown in FIG. 13, process 1300 may include disabling a power saving feature for an application at a first time (block 1310). For example, in an aspect, power saving component 720 and/or determining component 730 may disable the power saving feature for an application based at least in part on an evaluation of whether to enable or disable the power saving feature for the application, as described above in connection with FIG. 12. The power saving component 720 and/or determining component 730 may disable the power saving feature for the application at a first time, such as after performing the evaluation.

As shown in FIG. 13, process 1300 may include determining to re-evaluate whether to enable or disable the power saving feature for the application after disabling the power saving feature for the application (block 1320). For example, in an aspect, power saving component 720 and/or determining component 730 may determine to re-evaluate the power saving feature for the application after the first time (e.g., after the power saving feature has been disabled for the application). In some aspects, the application may be updated, and power saving component 720 and/or determining component 730 may determine to re-evaluate based at least in part on determining that the application has been updated. Additionally, or alternatively, a threshold amount of time may have elapsed since a previous evaluation of whether to enable or disable the power saving feature for the application, and power saving component 720 and/or determining component 730 may determine to re-evaluate based at least in part on determining that the threshold amount of time has elapsed. Additionally, or alternatively, power saving component 720 and/or determining component 730 may determine to re-evaluate based at least in part on a battery level of the UE (e.g., a remaining amount of battery life), a request to enter a power saving mode, or the like.

As shown in FIG. 13, process 1300 may include determining, during a third time period when the power saving feature is disabled, a third performance parameter associated with the application (block 1330). For example, in an aspect, power saving component 720 and/or determining component 730 may determine a third performance parameter associated with the application. The power saving component 720 and/or determining component 730 may determine the third performance parameter during a third time period when a power saving feature is disabled for the application. In some aspects, the third performance parameter may be a disabled feature parameter because the third performance parameter is determined during a time period when the power saving feature is disabled. In some aspects, power saving component 720 and/or determining component 730 may determine the third performance parameter in a similar manner as determining the first performance parameter, described above in connection with block 1210 of FIG. 12.

The third performance parameter may include, for example, a number of times that the UE exits an idle mode (e.g., a number of times that the application causes the UE to exit the idle mode), a number of times that the UE enters an RRC connected mode (e.g., a number of times that the application causes the UE to enter the RRC connected mode), a number of RRC connections triggered by the application, or the like. In some aspects, the third performance parameter may be the same type of performance parameter that was previously evaluated.

As shown in FIG. 13, process 1300 may include determining, during a fourth time period when the power saving feature is enabled, a fourth performance parameter associated with the application (block 1340). For example, in an aspect, power saving component 720 and/or determining component 730 may determine a fourth performance parameter associated with the application. The UE may determine the fourth performance parameter during a fourth time period when a power saving feature is enabled for the application. In some aspects, the fourth performance parameter may be an enabled feature parameter because the fourth performance parameter is determined during a time period when the power saving feature is enabled. In some aspects, power saving component 720 and/or determining component 730 may determine the fourth performance parameter in a similar manner as determining the second performance parameter, described above in connection with block 1220 of FIG. 12.

The fourth performance parameter may include, for example, a number of times that the UE exits an idle mode (e.g., a number of times that the application causes the UE to exit the idle mode), a number of times that the UE enters an RRC connected mode (e.g., a number of times that the application causes the UE to enter the RRC connected mode), a number of RRC connections triggered by the application, or the like. In some aspects, the fourth performance parameter may be the same type of performance parameter that was previously evaluated. Additionally, or alternatively, the fourth performance parameter may be the same type of parameter as the third performance parameter.

As shown in FIG. 13, process 1300 may include determining, based at least in part on determining to re-evaluate, whether to enable or disable the power saving feature for the application at a second time based at least in part on the third performance parameter and the fourth performance parameter (block 1350). For example, in an aspect, power saving component 720 and/or determining component 730 may determine whether to enable or disable the power saving feature at a second time (e.g., after the first time) based at least in part on the third performance parameter and the fourth performance parameter, in a similar manner as described above in connection with block 1240 of FIG. 12.

In this way, the UE may re-evaluate whether to enable or disable the power saving feature for the application when, for example, a behavior of the power saving feature, the application, and/or the UE may have changed. By selectively enabling or disabling the power saving feature over time for different applications based on performance, the UE may reduce power consumption and conserve power.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

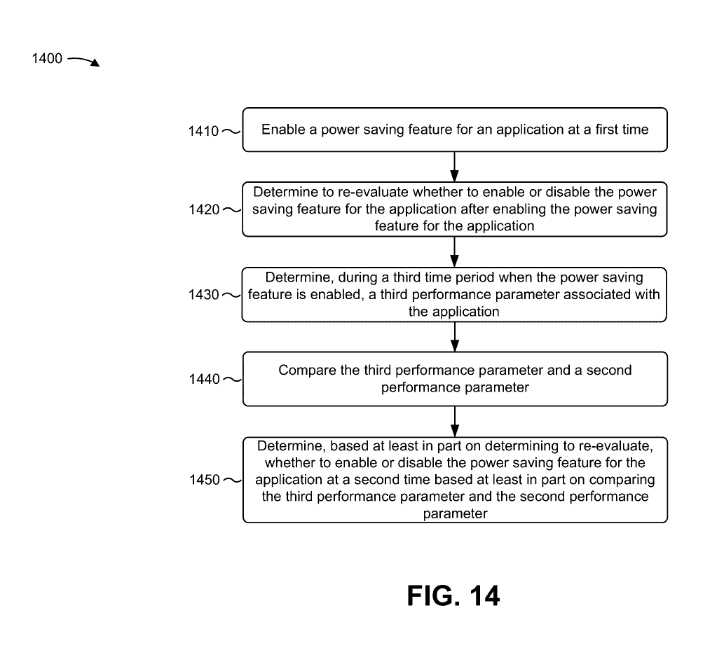

FIG. 14 is a flow diagram of an example process 1400 for re-evaluating whether to enable or disable a power saving feature for an application after the power saving feature has been enabled for the application, in accordance with various aspects of the present disclosure. In some aspects, one or more process blocks of FIG. 14 may be performed by one or more UEs described herein. In some aspects, one or more process blocks of FIG. 14 may be performed by another device or a plurality of devices separate from or including a UE.

As shown in FIG. 14, process 1400 may include enabling a power saving feature for an application at a first time (block 1410). For example, in an aspect, power saving component 720 and/or determining component 730 may enable the power saving feature for an application based at least in part on an evaluation of whether to enable or disable the power saving feature for the application, as described above in connection with FIG. 12. The power saving component 720 and/or determining component 730 may enable the power saving feature for the application at a first time, such as after performing the evaluation.

As shown in FIG. 14, process 1400 may include determining to re-evaluate whether to enable or disable the power saving feature for the application after enabling the power saving feature for the application (block 1420). For example, in an aspect, power saving component 720, and/or determining component 730 may determine to re-evaluate the power saving feature for the application after the first time (e.g., after the power saving feature has been enabled for the application). In some aspects, the application may be updated, and power saving component 720 and/or determining component 730 may determine to re-evaluate based at least in part on determining that the application has been updated. Additionally, or alternatively, a threshold amount of time may have elapsed since a previous evaluation of whether to enable or disable the power saving feature for the application, and power saving component 720 and/or determining component 730 may determine to re-evaluate based at least in part on determining that the threshold amount of time has elapsed.

As shown in FIG. 14, process 1400 may include determining, during a third time period when the power saving feature is enabled, a third performance parameter associated with the application (block 1430). For example, in an aspect, power saving component 720 and/or determining component 730 may determine a third performance parameter associated with the application. The power saving component 720 and/or determining component 730 may determine the third performance parameter during a third time period when a power saving feature is enabled for the application. In some aspects, the third performance parameter may be an enabled feature parameter because the third performance parameter is determined during a time period when the power saving feature is enabled. In some aspects, power saving component 720 and/or determining component 730 may determine the third performance parameter in a similar manner as determining the second performance parameter, described above in connection with block 1220 of FIG. 12.

The third performance parameter may include, for example, a number of times that the UE exits an idle mode (e.g., a number of times that the application causes the UE to exit the idle mode), a number of times that the UE enters an RRC connected mode (e.g., a number of times that the application causes the UE to enter the RRC connected mode), a number of RRC connections triggered by the application, or the like. In some aspects, the third performance parameter may be the same type of performance parameter that was previously evaluated. Additionally, or alternatively, the third performance parameter may be the same type of parameter as the second performance parameter.

As shown in FIG. 14, process 1400 may include comparing the third performance parameter and a second performance parameter (block 1440). For example, in an aspect, power saving component 720 and/or comparing component 736 may compare the second performance parameter, determined as described above in connection with FIG. 12, and the third performance parameter, determined as described above in connection with block 1430 of FIG. 14. In other words, the power saving component 720 and/or comparing component 736 may compare a first enabled feature parameter, determined during a prior time period, and a second enabled feature parameter determined during a later time period. In some aspects, power saving component 720 and/or comparing component 736 may compare the performance parameters to determine whether the second performance parameter is greater than, less than, or equal to the third performance parameter. The UE and/or power saving component 720 may use this comparison to determine whether to enable or disable the power saving feature for the application.

In some aspects, the UE and/or power saving component 720 may modify the second performance parameter and/or the third performance parameter using a weight value. In this case, and as an example, the UE may compare a weighted second performance parameter and the third performance parameter. As another example, power saving component 720 and/or comparing component 736 may compare the second performance parameter and a weighted third performance parameter. As another example, the UE may compare a weighted second performance parameter and a weighted third performance parameter.

As shown in FIG. 14, process 1400 may include determining, based at least in part on determining to re-evaluate, whether to enable or disable the power saving feature for the application at a second time based at least in part on the third performance parameter and the second performance parameter (block 1450). For example, in an aspect, power saving component 720 and/or determining component 730 may determine whether to enable or disable the power saving feature at a second time (e.g., after the first time) based at least in part on the third performance parameter and the second performance parameter, such as by comparing the third performance parameter and the second performance parameter.

In some aspects, power saving component 720 and/or determining component 730 may determine to keep the power saving feature enabled for the application, such as when the second performance parameter is greater than or equal to the third performance parameter. In some aspects, power saving component 720 and/or determining component 730 may determine to perform a full re-evaluation (e.g., using process 1200, described above in connection with FIG. 12), such as when the third performance parameter is greater than or equal to the second performance parameter.

In this way, the UE and/or power saving component 720 may re-evaluate whether to enable or disable the power saving feature for the application when, for example, a behavior of the power saving feature, the application, and/or the UE may have changed. By selectively enabling or disabling the power saving feature over time for different applications based at least in part on performance, the UE may reduce power consumption and conserve power.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

In some aspects, a UE and/or power saving component 720 may perform an evaluation (e.g., as described in connection with FIG. 12) and/or a re-evaluation (e.g., as described in connection with FIG. 13 and FIG. 14) for an individual application or multiple applications. For example, the UE and/or power saving component 720 may perform the evaluation and/or the re-evaluation for all applications installed on the UE or for a subset of the application installed on the UE. In some aspects, the UE and/or power saving component 720 may identify a subset of application for an evaluation and/or a re-evaluation based at least in part on user input, a power consumption of applications (e.g., applications with the largest power consumption), or the like.

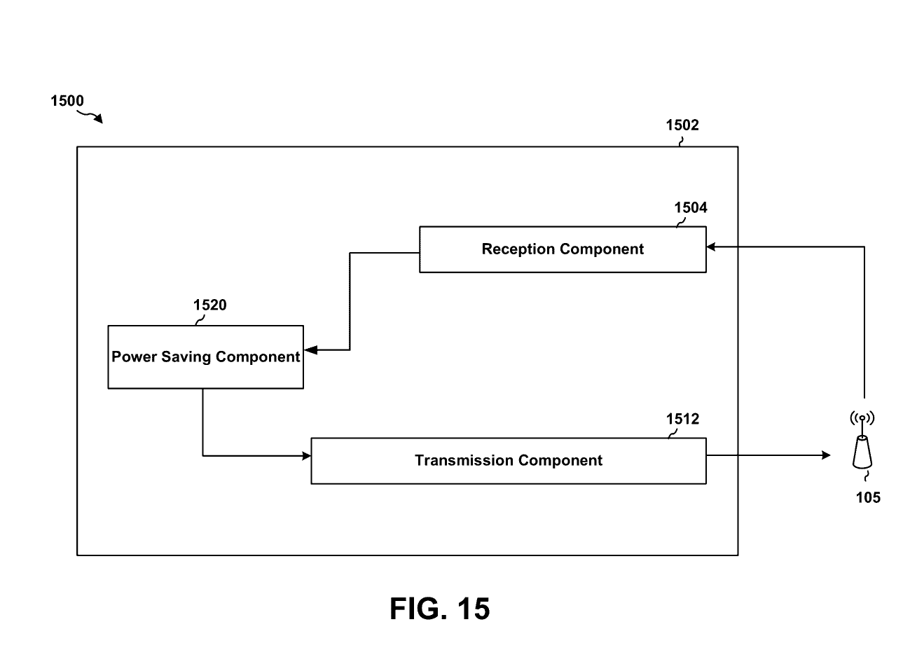

FIG. 15 is a conceptual data flow diagram 1500 illustrating the data flow between different means/components in an exemplary apparatus 1502 that includes power saving component 1520, which may be the same as or similar to power saving component 720. The apparatus 1502 may be a UE, which may include UE 115 FIGS. 1 and 7. The apparatus 1502 includes reception component 1504 that, in an aspect, receives information used by apparatus 1502 to configure one or more performance parameters, such as a first performance parameter and a second performance parameter. The apparatus 1502 includes a power saving component 1520 that may dynamically enable or disable a user equipment power saving feature based on application performance. In an aspect, the apparatus 1502 further includes transmission component 1512 that modify transmission schedules based on the power saving component 1520 dynamically enabling or disabling a user equipment power saving feature based on application performance.

The apparatus may include additional components that perform each of the blocks of the algorithm in the aforementioned flowcharts of FIG. 15. As such, each block in the aforementioned flowcharts of FIG. 15 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

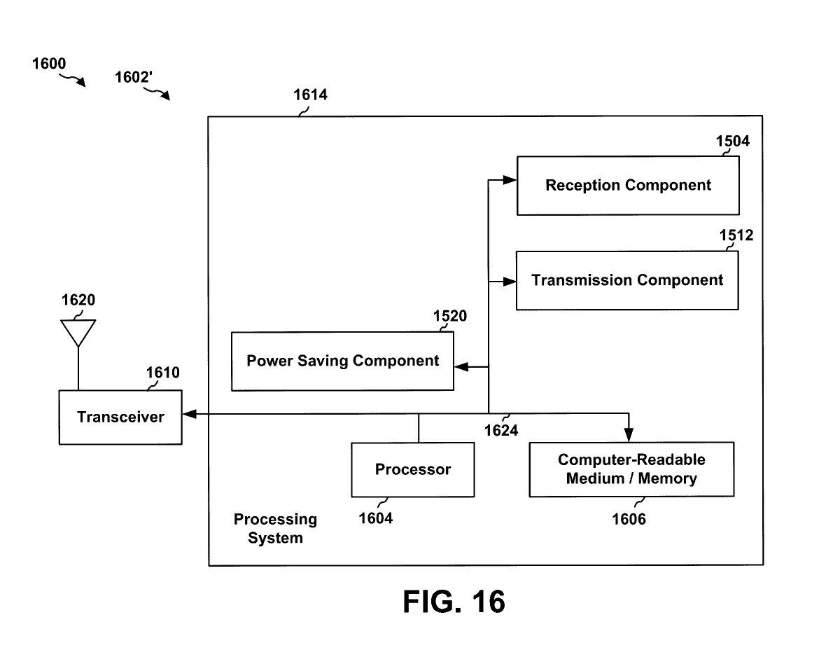

FIG. 16 is a diagram 1600 illustrating an example of a hardware implementation for an apparatus 1602′ employing a processing system 1614 that includes power saving component 1520 (FIG. 15), which may be the same as or similar to power saving component 720. The processing system 1614 may be implemented with a bus architecture, represented generally by the bus 1624. The bus 1624 may include any number of interconnecting buses and bridges depending on the specific application of the processing system 1614 and the overall design constraints. The bus 1624 links together various circuits including one or more processors and/or hardware components, represented by the processor 1604, the components 1504, 1608, 1612, and 1620, and the computer-readable medium/memory 1606. The bus 1624 may also link various other circuits such as timing sources, peripherals, voltage regulators, and power management circuits, which are well known in the art, and therefore, will not be described any further.

The processing system 1614 may be coupled to a transceiver 1610. The transceiver 1610 is coupled to one or more antennas 1620. The transceiver 1610 provides a means for communicating with various other apparatus over a transmission medium. The transceiver 1610 receives a signal from the one or more antennas 1620, extracts information from the received signal, and provides the extracted information to the processing system 1614, specifically the reception component 1504. In addition, the transceiver 1610 receives information from the processing system 1614, specifically the transmission component 1612, and based on the received information, generates a signal to be applied to the one or more antennas 1620. The processing system 1614 includes a processor 1604 coupled to a computer-readable medium/memory 1606. The processor 1604 is responsible for general processing, including the execution of software stored on the computer-readable medium/memory 1606. The software, when executed by the processor 1604, causes the processing system 1614 to perform the various functions described supra for any particular apparatus. The computer-readable medium/memory 1606 may also be used for storing data that is manipulated by the processor 1304 when executing software. The processing system 1614 further includes at least one of the components 1520, 1504, 1608, and 1512. The components may be software components running in the processor 1604, resident/stored in the computer readable medium/memory 1606, one or more hardware components coupled to the processor 1604, or some combination thereof.

In one configuration, the apparatus 1602/1602′ for wireless communication includes means for determining and during a first time period when a power saving feature is disabled, a first performance parameter associated with an application executing on the UE. The apparatus includes means for determining, by the UE and during a second time period when the power saving feature is enabled, a second performance parameter associated with the application executing on the UE. Further, in another configuration, the apparatus 1602/1602′ for wireless communication includes means for determining, by the UE, whether to enable or disable the power saving feature for the application based at least in part on the first performance parameter and the second performance parameter.

The aforementioned means may be one or more of the aforementioned components of the apparatus 1602 and/or the processing system 1614 of the apparatus 1602′ configured to perform the functions recited by the aforementioned means. As described supra, the processing system 1614 may include the TX Processor 666, the RX Processor 656, and the controller/processor 680. As such, in one configuration, the aforementioned means may be the TX Processor 666, the RX Processor 656, and the controller/processor 680 configured to perform the functions recited by the aforementioned means.

Techniques described herein may dynamically determine whether to enable or disable a power saving feature for an application based at least in part on measuring performance of the application and/or the UE with the power saving feature enabled and disabled. In this way, the UE may configure whether to enable or disable a power saving feature for an application, thereby increasing application and UE performance and reducing application and UE power consumption.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover: a; b; c; a and b; a and c; b and c; and a, b and c.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method for wireless communication, comprising:
determining, by a user equipment (UE) and during a first time period when a power saving feature is disabled, a first performance parameter associated with an application executing on the UE;
determining, by the UE and during a second time period when the power saving feature is enabled, a second performance parameter associated with the application executing on the UE; and
determining, by the UE, whether to enable or disable the power saving feature for the application based at least in part on the first performance parameter and the second performance parameter.

2. The method of claim 1, wherein determining whether to enable or disable the power saving feature comprises:
comparing the first performance parameter and the second performance parameter;
determining whether to enable or disable the power saving feature based at least in part on comparing the first performance parameter and the second performance parameter; and
enabling or disabling, by the UE, the power saving feature for the application based at least in part on determining whether to enable or disable the power saving feature for the application.

3. The method of claim 1, wherein the first performance parameter or the second performance parameter comprises at least one of:
a number of times that the UE exits an idle mode,
a number of times that the UE enters a radio resource control (RRC) connected mode,
a number of messages received, or
a number of RRC connections triggered by the application.

4. The method of claim 1, wherein determining the first performance parameter or determining the second performance parameter comprises:
determining that a duration of the first time period or the second time period satisfies a threshold; and
determining the first performance parameter or determining the second performance parameter based at least in part on determining that the duration of the first time period or the second time period satisfies the threshold.

5. The method of claim 1, wherein the first performance parameter or the second performance parameter is modified using a weight value.

6. The method of claim 1, wherein the first time period and the second time period are time periods during which a user is not actively using the UE.

7. The method of claim 1, wherein determining the first performance parameter and determining the second performance parameter comprises:
detecting that the application has been installed or updated on the UE; and
determining the first performance parameter and determining the second performance parameter based at least in part on detecting that the application has been installed or updated on the UE.

8. The method of claim 1, wherein determining the first performance parameter and determining the second performance parameter comprises:
determining that a threshold period of time has elapsed since a prior determination of whether to enable or disable the power saving feature; and
determining the first performance parameter and determining the second performance parameter based at least in part on determining that the threshold period of time has elapsed since the prior determination.

9. The method of claim 1, wherein the application is a first application;
wherein the power saving feature is enabled for the first application during a third time period; and
wherein the power saving feature is disabled for a second application during the third time period.

10. The method of claim 1, further comprising:
disabling the power saving feature for the application at a first time;
determining to re-evaluate whether to enable or disable the power saving feature for the application after disabling the power saving feature for the application;
determining, during a third time period when the power saving feature is disabled, a third performance parameter associated with the application;
determining, during a fourth time period when the power saving feature is enabled, a fourth performance parameter associated with the application; and
determining, based at least in part on determining to re-evaluate, whether to enable or disable the power saving feature for the application at a second time based at least in part on the third performance parameter and the fourth performance parameter.

11. The method of claim 1, further comprising:
enabling the power saving feature for the application at a first time;
determining to re-evaluate whether to enable or disable the power saving feature for the application after enabling the power saving feature for the application;
determining, during a third time period when the power saving feature is enabled, a third performance parameter associated with the application;
comparing the third performance parameter and the second performance parameter; and
determining, based at least in part on determining to re-evaluate, whether to enable or disable the power saving feature for the application at a second time based at least in part on comparing the third performance parameter and the second performance parameter.

12. The method of claim 1, wherein the first time period and the second time period include at least one learning time period during which a user is not actively using the UE, wherein the at least one learning time period begins after expiration of a margin time period; wherein the margin time period begins after detecting that the user is not actively using the UE, wherein a duration of the at least one learning time period satisfies a threshold, and further comprising:
periodically determining whether the application is executing during the at least one learning time period.

13. The method of claim 1, wherein the application is executing during the first time period and the second time period.

14. The method of claim 1, wherein determining the first performance parameter or determining the second performance parameter comprises:
determining that a user is not actively using the UE;
determining that the application has been executing on the UE for a threshold amount of time;
monitoring the UE for information relating to the first performance parameter or the second performance parameter based at least in part on determining that the user is not actively using the UE and determining that the application has been executing on the UE for the threshold amount of time;
determining the first performance parameter or determining the second performance parameter based at least in part on monitoring the UE for the information relating to the first performance parameter or the second performance parameter; and
determining that the user is actively using the UE or that the application has stopped executing on the UE; and
stopping the monitoring of the UE for the information relating to the first performance parameter or the second performance parameter based at least in part on determining that the user is actively using the UE or that the application has stopped executing on the UE.

15. A user equipment (UE) for wireless communication, comprising:
a memory configured to store instructions, and
one or more processors communicatively coupled with the memory, wherein the one or more processors are configured to execute the instructions to:
determine, during a first time period when a power saving feature is disabled, a first performance parameter associated with an application executing on the UE;
determine, during a second time period when the power saving feature is enabled, a second performance parameter associated with the application executing on the UE; and
determine whether to enable or disable the power saving feature for the application based at least in part on the first performance parameter and the second performance parameter.

16. The UE of claim 15, wherein the one or more processors, when determining whether to enable or disable the power saving feature, are to:
compare the first performance parameter and the second performance parameter;
determine whether to enable or disable the power saving feature based at least in part on comparing the first performance parameter and the second performance parameter; and
enable or disable the power saving feature for the application based at least in part on determining whether to enable or disable the power saving feature for the application.

17. The UE of claim 15, wherein the first performance parameter or the second performance parameter comprises at least one of:
a number of times that the UE exits an idle mode,
a number of times that the UE enters a radio resource control (RRC) connected mode,
a number of messages received, or
a number of RRC connections triggered by the application.

18. The UE of claim 15, wherein the one or more processors, when determining the first performance parameter or determining the second performance parameter, are to:
determine that a duration of the first time period or the second time period satisfies a threshold; and
determine the first performance parameter or determine the second performance parameter based at least in part on determining that the duration of the first time period or the second time period satisfies the threshold.

19. The UE of claim 15, wherein the first performance parameter or the second performance parameter is modified using a weight value.

20. The UE of claim 15, wherein the first time period and the second time period are time periods during which a user is not actively using the UE.

21. The UE of claim 15, wherein the one or more processors, when determining the first performance parameter and determining the second performance parameter, are to:
detect that the application has been installed or updated on the UE; and
determine the first performance parameter and determine the second performance parameter based at least in part on detecting that the application has been installed or updated on the UE.

22. The UE of claim 15, wherein the one or more processors, when determining the first performance parameter and determining the second performance parameter, are to:
determine that a threshold period of time has elapsed since a prior determination of whether to enable or disable the power saving feature; and
determine the first performance parameter and determine the second performance parameter based at least in part on determining that the threshold period of time has elapsed since the prior determination.

23. The UE of claim 15, wherein the application is a first application;
wherein the power saving feature is enabled for the first application during a third time period; and
wherein the power saving feature is disabled for a second application during the third time period.

24. The UE of claim 15, wherein the one or more processors are to:
disable the power saving feature for the application at a first time;
determine to re-evaluate whether to enable or disable the power saving feature for the application after disabling the power saving feature for the application;
determine, during a third time period when the power saving feature is disabled, a third performance parameter associated with the application;
determine, during a fourth time period when the power saving feature is enabled, a fourth performance parameter associated with the application; and
determine, based at least in part on determining to re-evaluate, whether to enable or disable the power saving feature for the application at a second time based at least in part on the third performance parameter and the fourth performance parameter.

25. The UE of claim 15, wherein the one or more processors are to:
enable the power saving feature for the application at a first time;
determine to re-evaluate whether to enable or disable the power saving feature for the application after enabling the power saving feature for the application;
determine, during a third time period when the power saving feature is enabled, a third performance parameter associated with the application;
compare the third performance parameter and the second performance parameter; and
determine, based at least in part on determining to re-evaluate, whether to enable or disable the power saving feature for the application at a second time based at least in part on comparing the third performance parameter and the second performance parameter.

26. The UE of claim 15, wherein the first time period and the second time period include at least one learning time period during which a user is not actively using the UE, wherein the at least one learning time period begins after expiration of a margin time period, wherein the margin time period begins after detecting that the user is not actively using the UE, wherein a duration of the at least one learning time period satisfies a threshold, and wherein the one or more processors are to:
periodically determine whether the application is executing during the at least one learning time period.

27. The UE of claim 15, wherein the application is executing during the first time period and the second time period.

28. The UE of claim 15, wherein the one or more processors, when determining the first performance parameter or determining the second performance parameter, are to:
determine that a user is not actively using the UE;
determine that the application has been executing on the UE for a threshold amount of time;
monitor the UE for information relating to the first performance parameter or the second performance parameter based at least in part on determining that the user is not actively using the UE and determining that the application has been executing on the UE for the threshold amount of time;
determine the first performance parameter or determine the second performance parameter based at least in part on monitoring the UE for the information relating to the first performance parameter or the second performance parameter;
determine that the user is actively using the UE or that the application has stopped executing on the UE; and
stop the monitoring of the UE for the information relating to the first performance parameter or the second performance parameter based at least in part on determining that the user is actively using the UE or that the application has stopped executing on the UE.

29. A computer-readable medium storing computer executable code for wireless communication, comprising:
code for determining, during a first time period when a power saving feature is disabled, a first performance parameter associated with an application executing on the UE;
code for determining, during a second time period when the power saving feature is enabled, a second performance parameter associated with the application executing on the UE; and
code for determining whether to enable or disable the power saving feature for the application based at least in part on the first performance parameter and the second performance parameter.

30. An apparatus for wireless communication, comprising:
means for determining, during a first time period when a power saving feature is disabled, a first performance parameter associated with an application executing on a user equipment (UE);
means for determining, during a second time period when the power saving feature is enabled, a second performance parameter associated with the application executing on the UE; and
means for determining whether to enable or disable the power saving feature for the application based at least in part on the first performance parameter and the second performance parameter.
